(19) United States
(12) Patent Application Publication
(10) Pub. No.: US 2025/0208383 A1
(43) Pub. Date: Jun. 26, 2025

(54) OPTICAL IMAGING SYSTEM

(71) Applicant: Samsung Electro-Mechanics Co., Ltd., Suwon-si (KR)

(72) Inventors: Tae Yeon LIM, Suwon-si (KR); Byung Hyun KIM, Suwon-si (KR); So Mi YANG, Suwon-si (KR); You Jin JEONG, Suwon-si (KR); Yong Joo JO, Suwon-si (KR); Jae Hyuk HUH, Suwon-si (KR)

(73) Assignee: Samsung Electro-Mechanics Co., Ltd., Suwon-si (KR)

(21) Appl. No.: 18/932,212

(22) Filed: Oct. 30, 2024

(30) Foreign Application Priority Data
Dec. 20, 2023 (KR) 10-2023-0187415

(51) Int. Cl. G02B 13/00; G02B 9/62

(52) U.S. Cl. CPC G02B 13/0065; G02B 9/62

(57) ABSTRACT

An optical imaging system includes a reflective member having a reflective surface for changing a path of light; a first lens group, disposed on a front side of the reflective member, comprising one or more lenses; and a second lens group, disposed on a rear side of the reflective member, comprising a plurality of lenses. Each of the first lens group and the second lens group has positive refractive power. An object-side surface of a frontmost lens disposed closest to an object side, among the one or more lenses of the first lens group, is convex. 0.5<fG1/fG2<2.5 is satisfied, where fG1 is a focal length of the first lens group, and fG2 is a focal length of the second lens group.

### CROSS-REFERENCE TO RELATED APPLICATIONS

This application claims the benefit under 35 USC 119(a) of Korean Patent Application No. 10-2023-0187415, filed on Dec. 20, 2023, in the Korean Intellectual Property Office, the entire disclosure of which is incorporated herein by reference for all purposes.

### BACKGROUND

### 1. Field

The present disclosure relates to an optical imaging system.

### 2. Description of the Background

Portable terminals may include a camera with an optical imaging system with a plurality of lenses to enable video calls and the capturing of images.

Portable terminals with cameras may be miniaturized, making it desirable to develop a corresponding optical imaging system with a high resolution.

To implement a camera for a portable terminal having telephoto properties, an optical axis of a plurality of lenses may be disposed to be parallel to a length direction or a width direction of a portable terminal, and a reflective member may be disposed on a front side of the plurality of lenses such that a total track length of the optical imaging system may not affect a thickness of the portable terminal.

However, in this structure, as the diameters of the plurality of lenses increase, the thickness of the portable terminal may also undesirably increase.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a reflective member having a reflective surface for changing a path of light; a first lens group, disposed on a front side of the reflective member, comprising one or more lenses; and a second lens group, disposed on a rear side of the reflective member, comprising a plurality of lenses. Each of the first lens group and the second lens group has positive refractive power. An object-side surface of a frontmost lens disposed closest to an object side, among the one or more lenses of the first lens group, is convex. 0.5<fG1/fG2<2.5 is satisfied, where fG1 is a focal length of the first lens group, and fG2 is a focal length of the second lens group.

The reflective member and the first lens group may be configured to rotate with respect to two axes perpendicular to each other.

One of the two axes may be an optical axis of the first lens group or an axis parallel to the optical axis of the first lens group.

The reflective member may include an incident surface to which light is incident and an emitting surface from which light is emitted, and the reflective surface may be disposed between the incident surface and the emitting surface. An effective diameter of an object-side surface of the frontmost lens of the first lens group and an effective diameter of an image-side surface of the frontmost lens of the first lens group may be greater than a minor axis length of the incident surface of the reflective member.

The optical imaging system may satisfy 0.4<R1/R2<0.9, where R1 is a radius of curvature of the object-side surface of the frontmost lens of the first lens group, and R2 is a radius of curvature of an image-side surface of the frontmost lens of the first lens group.

The optical imaging system may satisfy −0.3<(R1−R2)/(R1+R2)<0.

The optical imaging system may satisfy 1<SAG11/SAG12<2.5, where SAG11 is an SAG value on an effective diameter end of the object-side surface of the frontmost lens of the first lens group, and SAG12 is an SAG value on an effective diameter end of an image-side surface of the frontmost lens of the first lens group.

The optical imaging system may satisfy 1<fG1/f<3, where f is a total focal length of the optical imaging system.

The optical imaging system may satisfy 1<CA_L11/CA_L21<3, where CA_L11 is an effective diameter of the object-side surface of the frontmost lens of the first lens group, and CA_L21 is an effective diameter of an object-side surface of a frontmost lens disposed closest to the reflective member among the plurality of lenses of the second lens group.

The reflective member may include an incident surface to which light is incident and an emitting surface from which light is emitted, and the reflective surface is disposed between the incident surface and the emitting surface, and wherein 1.5<(Lf+DR)/CA_L21<3 may be satisfied, where Lf is a distance from the object-side surface of the frontmost lens of the first lens group to the reflective surface, DR is a distance from the incident surface to the reflective surface, and CA_L21 is an effective diameter of an object-side surface of a frontmost lens disposed closest to the reflective member among the plurality of lenses of the second lens group.

The optical imaging system may satisfy 0.5 [mm]<CA_L21/Fno<2 [mm], where CA_L21 is an effective diameter of an object-side surface of a frontmost lens disposed closest to the reflective member among the plurality of lenses of the second lens group, and Fno is an F-number of the optical imaging system.

The reflective member may include an incident surface to which light is incident and an emitting surface from which light is emitted, and the reflective surface may be disposed between the incident surface and the emitting surface. The optical imaging system may satisfy DP2/fG2<0.4, where DP2 is a distance from the emitting surface to an object-side surface of a frontmost lens disposed closest to the reflective member among the plurality of lenses of the second lens group.

The optical imaging system may satisfy 3<fG1/f2<11, where f2 is a focal length of a frontmost lens disposed closest to the reflective member among the plurality of lenses of the second lens group.

The optical imaging system may satisfy −4<f2/f3<0, where f2 is a focal length of a frontmost lens disposed closest to the reflective member among the plurality of lenses of the second lens group, and f3 is a focal length of a lens disposed second closest to the reflective member among the plurality of lenses of the second lens group.

One or more lenses of the first lens group may be the first lens, and the plurality of lenses of the second lens group may include a second lens, a third lens, a fourth lens, a fifth lens and a sixth lens.

An image-side surface of the first lens may be concave, the second lens may have positive refractive power, the third lens may have negative refractive power, and a focal length of the first lens may be greater than a focal length of the second lens.

Other features and aspects will be apparent from the following detailed description, the drawings, and the claims.

### BRIEF DESCRIPTION OF DRAWINGS

FIG. 1 is a configuration diagram illustrating an optical imaging system according to a first embodiment of the present disclosure.

FIG. 2 is a configuration diagram illustrating an optical imaging system according to a second embodiment of the present disclosure.

FIG. 3 is a configuration diagram illustrating an optical imaging system according to a third embodiment of the present disclosure.

FIG. 4 is a configuration diagram illustrating an optical imaging system according to a fourth embodiment of the present disclosure.

FIG. 5 is a configuration diagram illustrating an optical imaging system according to a fifth embodiment of the present disclosure.

FIG. 6 is a configuration diagram illustrating an optical imaging system according to a sixth embodiment of the present disclosure.

FIG. 7 is a configuration diagram illustrating an optical imaging system according to a seventh embodiment of the present disclosure.

FIG. 8 is a configuration diagram illustrating an optical imaging system according to an eighth embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An effective aperture radius of a lens surface is a radius of a portion of the lens surface through which light actually passes, and is not necessarily a radius of an outer edge of the lens surface. An object-side surface of a lens and an image-side surface of the lens may have different effective aperture radiuses.

Stated another way, an effective aperture radius of a lens surface is a distance in a direction perpendicular to an optical axis of the lens surface between the optical axis of the lens surface and a marginal ray of light passing through the lens surface.

$$Z = cY \hat{} 2 / ( 1 + √ ( 1 - ( 1 + K )$$

$$c \hat{} 2 Y \hat{} 2 ) ) + AY \hat{} 4 + BY \hat{} 6 + CY \hat{} 8 + DY \hat{} 10 + EY \hat{} 12 + FY \hat{} 14 + GY \hat{} 16 + HY \hat{} 18 + JY \hat{} 20 …$$

$$Z = cY \hat{} 2 / ( 1 + √ ( 1 - ( 1 + k )$$

$$c \hat{} 2 Y \hat{} 2 ) ) + AY \hat{} 4 + BY \hat{} 6 + CY \hat{} 8 + DY \hat{} 10 + EY \hat{} 12 + FY \hat{} 14 + GY \hat{} 16 + HY \hat{} 18 + JY \hat{} 20 + LY \hat{} 22 + MY \hat{} 24 + NY \hat{} 26 + OY \hat{} 28 + PY \hat{} 30$$

$$Z = cr \hat{} 2 / ( 1 + √ ( 1 - ( 1 + k )$$

$$c \hat{} 2 r \hat{} 2 ) ) + Ar \hat{} 4 + Br \hat{} 6 + Cr \hat{} 8 + Dr \hat{} 10 + Er \hat{} 12 + Fr \hat{} 14 + Gr \hat{} 16 + Hr \hat{} 18 + Jr \hat{} 20 …$$

An optical imaging system, according to embodiments, may be mounted on a portable electronic device. For example, an optical imaging system may be configured as a component of a camera module mounted on a portable electronic device. A portable electronic device may be implemented as a mobile communication terminal, a smartphone, and a tablet PC.

In embodiments, a unit of values of radius of curvature, thickness, distance, focal length, and the like, may be mm, and a unit of a field of view may be degree.

In the description related to the shape of a lens of the embodiments, a convex surface may indicate that a paraxial region portion of the surface may be convex, and a concave surface may indicate that a paraxial region portion of the surface may be concave.

A paraxial region may refer to a relatively narrow area near the optical axis.

An imaging plane may refer to a virtual plane on which a focus is formed by the optical imaging system. Alternatively, the imaging plane may refer to one surface of the image sensor in which light is received.

An optical imaging system, according to an embodiment, may include a plurality of lens groups. As an example, the optical imaging system may include a first lens group and a second lens group.

The first lens group may include one or more lenses, and the second lens group may include a plurality of lenses.

In an embodiment, the first lens group may include a first lens, and the second lens group may include a second lens, a third lens, a fourth lens, a fifth lens, and a sixth lens. The first to sixth lenses may be disposed in order from an object side.

When the first lens group includes a plurality of lenses, a frontmost lens of the first lens group may refer to the first lens, and a frontmost lens of the second lens group may refer to the lens disposed closest to the first lens group among the plurality of lenses of the second lens group.

The plurality of lenses included in the optical imaging system may be spaced apart from each other.

The frontmost lens of the first lens group may have positive refractive power and an object-side surface thereof may be convex. An absolute value of a focal length of the frontmost lens of the second lens group may be smaller than a focal length of the first lens group.

Among the plurality of lenses of the second lens group, at least three lenses may have a refractive index greater than 1.6. Among the plurality of lenses of the second lens group, at least two lenses may have a refractive index greater than 1.63.

Among the plurality of lenses of the second lens group, the fifth lens may have the largest refractive index. In an embodiment, the fifth lens may have a refractive index of 1.66 or greater.

The optical imaging system may further include a reflective member with a reflective surface for changing an optical path. The reflective surface of the reflective member may be configured to change an optical path by 90°.

The reflective member may be disposed between the first lens group and the second lens group. In an embodiment, the reflective member may be disposed between the first lens and the second lens.

The reflective member may be implemented as a mirror or a prism with a reflective surface.

When the reflective member is implemented as a prism, the reflective member may have a form in which a rectangular parallelepiped or a cube is bisected diagonally. The prism may include an incident surface to which light is incident, a reflective surface configured to reflect light passing through the incident surface, and an emitting surface from which light reflected from the reflective surface is emitted.

The reflective member may include three surfaces, each with a quadrangular shape, and two surfaces, each with a triangular shape. For example, each of the incident surfaces, the reflective surface and the emitting surface of the reflective member, may have a quadrangular shape, and both surfaces of the reflective member may have an almost triangular shape.

An optical axis of the first lens group and an optical axis of the second lens group may be perpendicular to each other. In an embodiment, the optical axis direction of the first lens group may be substantially parallel to a thickness direction of a portable terminal on which the optical imaging system is mounted, and the optical axis direction of the second lens group may be substantially parallel to a length direction or a width direction of the portable terminal.

By changing the direction of light through the reflective member, an optical path may be elongated in a relatively narrow space.

For example, light passing through the first lens may pass through the incident surface of the reflective member, the optical path of light may be changed by 90° on the reflective surface, light may pass through the emitting surface of the reflective member and may be incident to the second lens.

Accordingly, the optical imaging system may have a relatively long focal length while having a reduced size.

According to an embodiment, the optical imaging system may have characteristics of a telephoto lens having a relatively narrow field of view and a relatively long focal length.

To reduce the sizes of the portable terminal and the optical imaging system, reducing the diameters of lenses positioned between the reflective member and the image sensor may be desirable. However, as the diameter of the lenses reduces, Fno (the F-number of the optical imaging system) increases, images may be darkened.

Accordingly, the optical imaging system according to an embodiment may reduce Fno by disposing the first lens group having positive refractive power on a front side of the reflective member. Also, an effective diameter of an object-side surface and an effective diameter of an image-side surface of a lens included in the first lens group may be greater than a minor axis length of the incident surface of the reflective member.

The lens included in the first lens group may have an almost circular shape when viewed in the optical axis direction of the first lens group.

The reflective member may be disposed on a front side of the second lens group. The reflective member may rotate with respect to two axes for image stabilization during photographing.

In other words, when shaking occurs due to factors such as hand-shake of a user when obtaining an image or video, image stabilization may be performed by rotating the reflective member in response to the shaking.

In an embodiment, the reflective member may rotate using an optical axis of the first lens group (or an axis parallel to the axis) as a rotation axis (Yaw rotation axis), and may rotate using an axis perpendicular to both the optical axis of the first lens group and the optical axis of the second lens group (or an axis parallel to the axis) as a rotation axis (pitch rotation axis).

Since the first lens group having positive refractive power is disposed on a front side of the reflective member, light incident to the reflective member may be converged, and accordingly, a diameter of the second lens group may be configured to be small. Accordingly, a height of the optical imaging system may be reduced, and also the Fno of the optical imaging system may be reduced.

Also, the first lens group may rotate together with the reflective member.

The optical imaging system may further include an image sensor for converting an image of an incident subject into an electrical signal.

Also, the optical imaging system may further include an infrared cut-off filter (hereinafter, referred to as a “filter”) to block infrared rays. The filter may be disposed between the second lens group and the imaging plane.

Also, the optical imaging system may further include an aperture for controlling the amount of light.

An effective radius of the first lens may be greater than an effective radius of other lenses. In other words, among the first to sixth lenses, the effective radius of the first lens may be the largest.

The first lens may have a shape different from those of the other lenses. For example, when viewed in the optical axis direction of the first lens, the first lens may have a substantially circular shape. One or more lenses among the second to the sixth lens may have a non-circular shape. For example, a length of a non-circular lens in the first axis (X-axis) direction perpendicular to the optical axis may be longer than a length in the second axis (Y-axis) direction perpendicular to both the optical axis and the first axis (X-axis) direction. As for, a ratio of a length of a non-circular lens in the second axis (Y-axis) direction to a length in the first axis (X-axis) direction may be greater than 0.5 and less than 1.

Here, the first axis (X-axis) direction may be the direction in which a long side of the image sensor extends, and the second axis (Y-axis) direction may be the direction in which a short side of the image sensor extends.

A length in the first axis (X-axis) direction of the non-circular lens may be longer than a length in the second axis (Y-axis) direction, such that an effective radius in the first axis (X-axis) direction may be greater than an effective radius in the second axis (Y-axis) direction.

In an embodiment, the first to sixth lenses may be formed of a plastic material.

In an embodiment, an object-side surface and an image-side surface of a lens included in the first lens group may be aspherical.

In an embodiment, an object-side surface and an image-side surface of one or more lenses among the plurality of lenses included in the second lens group may be aspherical.

Here, the aspherical surface of each lens may be represented as equation 1.

$$Equation 1$$

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} …$$

In equation 1, c may be the curvature of the lens surface (reciprocal of the radius of curvature), K may be the conic constant, and Y may be the distance from an arbitrary point on the aspherical surface of the lens to the optical axis. Also, constants A-P may be aspherical surface coefficients. Z(SAG) may be the distance in the optical axis direction between an arbitrary point on the aspherical surface of the lens and an apex of the aspherical surface.

According to an embodiment, an optical imaging system may satisfy one or more of the conditional expressions below.

In an embodiment, the optical imaging system may satisfy condition 0.4<R1/R2<0.9. Here, R1 may be the radius of curvature of an object-side surface of the frontmost lens (e.g., first lens) of the first lens group, and R2 may be the radius of curvature of an image-side surface of the frontmost lens (e.g., first lens) of the first lens group. Accordingly, changes in optical path length due to rotation of the first lens group during image stabilization may be reduced, and image stabilization performance may be improved.

In an embodiment, the optical imaging system may satisfy condition 1<SAG11/SAG12<2.5. Here, SAG11 may be an SAG value on an effective diameter end of an object-side surface of the first lens, and SAG12 may be an SAG value on an effective diameter end of an image-side surface of the first lens. Accordingly, changes in optical path length due to rotation of the first lens group during image stabilization may be reduced, and image stabilization performance may be improved.

When the SAG value has a positive value, an effective diameter end of the corresponding lens surface may be positioned closer to an image side than an apex of the corresponding lens surface.

When the SAG value has a negative value, an effective diameter end of the lens surface may be positioned closer to an object side than an apex of the lens surface.

In an embodiment, the optical imaging system may satisfy condition 1<fG1/f<3. Here, fG1 may be the focal length of the first lens group, and f may be the total focal length of the optical imaging system. Accordingly, optimizing the focal length of the first lens group having positive refractive power may reduce the diameters of lenses included in the second lens group.

In an embodiment, the optical imaging system may satisfy condition 0.5<fG1/fG2<2.5. Here, fG2 may be the focal length of the second lens group. Accordingly, by appropriately distributing the refractive power of each lens group, the optical imaging system may have a reduced size and resolution may be improved.

In an embodiment, the optical imaging system may satisfy condition 1<CA_L11/CA_L21<3. Here, CA_L11 may be the effective diameter of the frontmost lens (e.g., first lens) of the first lens group, and CA_L21 may be the effective diameter in the second axis (Y-axis) direction of the frontmost lens (e.g., second lens) of the second lens group. Accordingly, image brightness may improve, and the optical imaging system may be reduced in size.

In an embodiment, the optical imaging system may satisfy condition 1.5<(Lf+DR)/CA_L21<3. Here, Lf may be the distance from an object-side surface of the frontmost lens (e.g., first lens) of the first lens group to the reflective surface of the reflective member, and DR may be the distance from the incident surface of the reflective member to the reflective surface of the reflective member (or, the distance from the reflective surface to the emitting surface). Accordingly, a thickness of the optical imaging system may be prevented from excessively increasing in the optical axis direction of the first lens group.

In an embodiment, the optical imaging system may satisfy condition 0.5 [mm]<CA_L21/Fno<2 [mm]. Here, Fno may be the F-number of the optical imaging system. Accordingly, image brightness may improve, and the optical imaging system may be reduced in size.

In an embodiment, the optical imaging system may satisfy condition DP2/fG2<0.4. Here, DP2 may be the distance from the emitting surface of the reflective member to an object-side surface of the frontmost lens (e.g., second lens) of the second lens group. Accordingly, interference between the reflective member and the second lens group may be prevented when the reflective member rotates. Also, a space in which the second lens group may move in the optical axis direction of the second lens group may be ensured for focus adjustment.

In an embodiment, the optical imaging system may satisfy condition 3<fG1/f2<11. Here, f2 may be the focal length of the frontmost lens (e.g., the second lens) of the second lens group. Accordingly, aberration may be reduced and also the optical imaging system may have sufficient telephoto performance.

In an embodiment, the optical imaging system may satisfy condition 3<f1/f2<11. Here, f1 may be the focal length of the frontmost lens (e.g., first lens) of the first lens group, and f2 may be the focal length of the frontmost lens (e.g., second lens) of the second lens group. Accordingly, aberration may be reduced and also the optical imaging system may have sufficient telephoto performance.

In an embodiment, the optical imaging system may satisfy condition −4<f2/f3<0. Here, f3 may be the focal length of the lens (e.g., third lens) disposed neighboring to the frontmost lens of the second lens group. Accordingly, aberration may be reduced and also the optical imaging system may have sufficient telephoto performance.

In an embodiment, the optical imaging system may satisfy condition −0.3<(R1−R2)/(R1+R2)<0. Accordingly, spherical aberration occurring in the first lens group may be reduced.

In an embodiment, the optical imaging system may satisfy condition 0.2<Lf/Lr<0.4. Here, Lr may be the distance from the reflective surface of the reflective member to the imaging plane. Accordingly, the optical imaging system may have a reduced size.

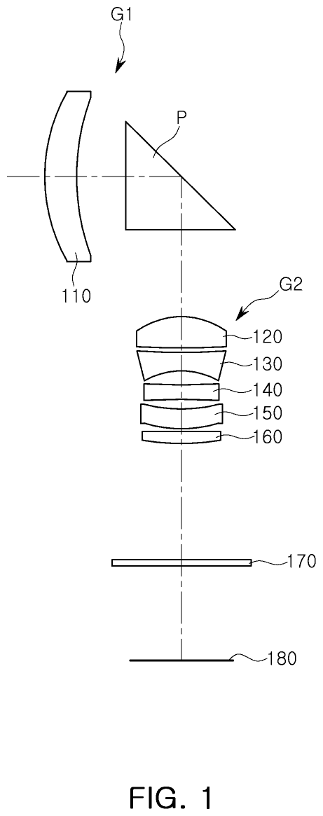

FIG. 1 is a configuration diagram illustrating an optical imaging system according to a first embodiment. An optical imaging system according to the first embodiment may be described with reference to FIG. 1.

The optical imaging system, according to the first embodiment, may include a first lens group G1 and a second lens group G2. The optical imaging system may include a reflective member P disposed between the first lens group G1 and the second lens group G2.

The first lens group G1 may include a first lens 110, and the second lens group G2 may include a second lens 120, a third lens 130, a fourth lens 140, a fifth lens 150 and a sixth lens 160, in order from an object side.

Also, the optical imaging system may further include a filter 170 and an image sensor.

The optical imaging system, according to the first embodiment, may form a focus on an imaging plane 180. The imaging plane 180 may refer to the surface on which focus is formed by the optical imaging system. As an example, the imaging plane 180 may refer to one surface of the image sensor in which light is received.

The reflective member P may be implemented as a prism, or may be provided as a mirror.

Lens characteristics (radius of curvature, thickness of the lens or distance between lenses, refractive index, Abbe number, and focal length) of each lens are listed in Table 1.

TABLE 1

| Surface | | Radius of | Thickness or | Refractive | Abbe | Focal |
|---|---|---|---|---|---|---|
| No. | Elements | curvature | distance | index | number | length |
| S1 | First | 8.092 | 1.300 | 1.535 | 55.7 | 38 |
| | lens | | | | | |
| S2 | | 12.654 | 2.046 | | | |
| S3 | Prism | Infinity | 2.250 | 1.785 | 25.7 | |
| S4 | | Infinity | 2.250 | 1.785 | 25.7 | |
| S5 | | Infinity | 3.560 | | | |
| S6 | Second | 3.393 | 1.253 | 1.535 | 55.7 | 5.774 |
| | lens | | | | | |
| S7 | Aperture | −31.504 | 0.165 | | | |
| S8 | Third | −40.723 | 0.786 | 1.614 | 25.9 | −4.328 |
| | lens | | | | | |
| S9 | | 2.894 | 0.583 | | | |
| S10 | Fourth | −35.858 | 0.619 | 1.544 | 56.0 | −42.056 |
| | lens | | | | | |
| S11 | | 64.351 | 0.367 | | | |
| S12 | Fifth | −8.018 | 0.831 | 1.661 | 20.4 | 24.482 |
| | lens | | | | | |
| S13 | | −5.605 | 0.100 | | | |
| S14 | Sixth | 52.801 | 0.480 | 1.639 | 23.5 | 32.386 |
| | lens | | | | | |
| S15 | | −34.489 | 4.838 | | | |
| S16 | Filter | Infinity | 0.210 | 1.517 | 64.2 | |
| S17 | | Infinity | 3.906 | | | |
| S18 | Imaging | Infinity | | | | |
| | plane | | | | | |

TABLE 2

| | |
|---|---|
| Effective | Effective |
| radius | radius |
| in X-axis | in Y-axis |
| direction | direction |

| | |
|---|---|
| First | 3.480 |
| lens | 3.228 |

| | | |
|---|---|---|
| Second | 2.060 | 1.825 |
| lens | 1.922 | 1.825 |
| Third | 1.842 | 1.825 |

| | |
|---|---|
| lens | 1.520 |
| Fourth | 1.540 |
| lens | 1.480 |
| Fifth | 1.580 |

| | | |
|---|---|---|
| lens | 1.716 | 1.600 |
| Sixth | 1.750 | 1.600 |
| lens | 1.800 | 1.600 |

Table 2 may list an effective radius in the first axis (X-axis) direction and an effective radius in the second axis (Y-axis) direction of each of the first lens 110 to the sixth lens 160. The first axis (X-axis) direction and the second axis (Y-axis) direction may indicate two directions perpendicular to the optical axis of each lens, and perpendicular to each other. For example, the optical axis of the first lens 110 and the optical axis of the second lens 120 may be perpendicular to each other, such that the first axis (X-axis) direction of the first lens 110 and the first axis (X-axis) direction of the second lens 210 may be different from each other.

The first lens 110 and the fourth lens 140 may have the same effective radius in the first axis (X-axis) direction and the same effective radius in the second axis (Y-axis) direction.

Effective radii in the first axis (X-axis) direction of an object-side surface and an image-side surface of each of the second lens 120 and the sixth lens 160 may be greater than effective radii in the second axis (Y-axis) direction.

The effective radius of an object-side surface of the third lens 130 in the first axis (X-axis) direction may be greater than the effective radius in the second axis (Y-axis) direction. An image-side surface of the third lens 130 may have the same effective radius in the first axis (X-axis) direction and the same effective radius in the second axis (Y-axis) direction.

An object-side surface of the fifth lens 150 may have the same effective radius in the first axis (X-axis) direction and the same effective radius in the second axis (Y-axis) direction. The effective radius in the first axis (X-axis) direction of an image-side surface of the fifth lens 150 may be greater than the effective radius in the second axis (Y-axis) direction.

In the first embodiment, the first lens group G1 may have positive refractive power entirely, and the second lens group G1 may have positive refractive power entirely.

The effective radius of an object-side surface of the first lens 110 of the first lens group G1 may be greater than the effective radius of an image-side surface.

The first lens 110 may have positive refractive power, an object-side surface of the first lens 110 may be convex, and an image-side surface of the first lens 110 may be concave.

The second lens 120 may have positive refractive power, and an object-side surface and an image-side surface of the second lens 120 may be convex.

The third lens 130 may have negative refractive power, and an object-side surface and an image-side surface of the third lens 130 may be concave.

The fourth lens 140 may have negative refractive power, and an object-side surface and an image-side surface of the fourth lens 140 may be concave.

The fifth lens 150 may have positive refractive power, an object-side surface of the fifth lens 150 may be concave, and an image-side surface of the fifth lens 150 may be convex.

The sixth lens 160 may have positive refractive power, and an object-side surface and an image-side surface of the sixth lens 160 may be convex.

An aperture may be disposed between the second lens 120 and the third lens 130.

Each surface of the first lens 110 to the sixth lens 160 may have an aspherical coefficient, as in Table 3. For example, an object-side surface and an image-side surface of each of the first lens 110 to the sixth lens 160 may be aspherical.

TABLE 3

| | S1 | S2 | S6 | S7 | S8 | S9 |
|---|---|---|---|---|---|---|
| Conic | −3.6762E+00 | 6.7425E+00 | 4.6658E−02 | 1.5680E−08 | −5.1135E−13 | −2.1689E−01 |
| constant (K) | | | | | | |
| 4th order | 1.9611E−03 | 1.2977E−03 | 1.3809E−03 | −4.4581E−04 | −5.8845E−03 | −7.9766E−03 |
| coefficient (A) | | | | | | |
| 6th order | −7.4003E−04 | −1.6673E−03 | −2.8511E−03 | 1.3279E−02 | −1.6500E−03 | 2.6877E−03 |
| coefficient (B) | | | | | | |
| 8th order | 6.5876E−04 | 1.9294E−03 | 8.8373E−03 | −3.8828E−02 | 3.5579E−02 | −2.5843E−03 |
| coefficient (C) | | | | | | |
| 10th order | −3.8408E−04 | −1.4419E−03 | −1.7908E−02 | 7.0548E−02 | −1.1637E−01 | 6.5456E−02 |
| coefficient (D) | | | | | | |
| 12th order | 1.5699E−04 | 7.4076E−04 | 2.3609E−02 | −8.1924E−02 | 2.3075E−01 | −2.7374E−01 |
| coefficient (E) | | | | | | |
| 14th order | −4.6548E−05 | −2.7105E−04 | −2.1011E−02 | 6.0544E−02 | −3.0610E−01 | 6.2762E−01 |
| coefficient (F) | | | | | | |
| 16th order | 1.0205E−05 | 7.2141E−05 | 1.2911E−02 | −2.6154E−02 | 2.8270E−01 | −9.3262E−01 |
| coefficient (G) | | | | | | |
| 18th order | −1.6634E−06 | −1.4092E−05 | −5.5236E−03 | 3.7553E−03 | −1.8539E−01 | 9.4846E−01 |
| coefficient (H) | | | | | | |
| 20th order | 2.0051E−07 | 2.0171E−06 | 1.6338E−03 | 2.5240E−03 | 8.6779E−02 | −6.7419E−01 |
| coefficient (J) | | | | | | |
| 22nd order | −1.7580E−08 | −2.0883E−07 | −3.2537E−04 | −1.7798E−03 | −2.8754E−02 | 3.3526E−01 |
| coefficient (L) | | | | | | |
| 24th order | 1.0866E−09 | 1.5198E−08 | 4.1054E−05 | 5.4420E−04 | 6.5802E−03 | −1.1441E−01 |
| coefficient (M) | | | | | | |
| 26th order | −4.4760E−11 | −7.3662E−10 | −2.8382E−06 | −9.3755E−05 | −9.8846E−04 | 2.5544E−02 |
| coefficient (N) | | | | | | |
| 28th order | 1.1007E−12 | 2.1324E−11 | 6.1005E−08 | 8.8391E−06 | 8.7659E−05 | −3.3621E−03 |
| coefficient (O) | | | | | | |
| 30th order | −1.2203E−14 | −2.7867E−13 | 2.2747E−09 | −3.5643E−07 | −3.4773E−06 | 1.9789E−04 |
| coefficient (P) | | | | | | |
| | S10 | S11 | S12 | S13 | S14 | S15 |
| Conic | 0.0000E+00 | 0.0000E+00 | 0.0000E+00 | 1.1371E−13 | 0.0000E+00 | 0.0000E+00 |
| constant (K) | | | | | | |
| 4th order | 4.9524E−03 | 1.3007E−02 | 2.7575E−03 | 5.1945E−03 | −6.3162E−03 | −9.2649E−03 |
| coefficient (A) | | | | | | |
| 6th order | 1.7251E−03 | −2.2927E−02 | −2.3682E−02 | −2.9208E−02 | −3.3232E−04 | −4.5243E−04 |
| coefficient (B) | | | | | | |
| 8th order | −3.1607E−02 | 4.3783E−02 | 6.3672E−02 | 1.0293E−01 | −1.0328E−04 | −4.3155E−05 |
| coefficient (C) | | | | | | |
| 10th order | 9.5996E−02 | −4.4579E−02 | −1.0443E−01 | −2.3297E−01 | 6.9335E−06 | −1.8078E−06 |
| coefficient (D) | | | | | | |
| 12th order | −1.4041E−01 | 2.0025E−02 | 1.1027E−01 | 3.6315E−01 | −8.3202E−06 | −1.5999E−06 |
| coefficient (E) | | | | | | |
| 14th order | 1.1238E−01 | 1.7921E−03 | −7.3846E−02 | −4.0380E−01 | 3.3944E−06 | −6.5121E−07 |
| coefficient (F) | | | | | | |
| 16th order | −5.0627E−02 | −6.0851E−03 | 2.9873E−02 | 3.2738E−01 | −1.7483E−09 | 4.7568E−07 |
| coefficient (G) | | | | | | |
| 18th order | 1.2046E−02 | 2.4737E−03 | −6.6083E−03 | −1.9556E−01 | −6.3674E−09 | −3.0870E−08 |
| coefficient (H) | | | | | | |
| 20th order | −1.1766E−03 | −3.3550E−04 | 6.1083E−04 | 8.6005E−02 | 4.6669E−10 | −2.0084E−09 |
| coefficient (J) | | | | | | |
| 22nd order | 0.0000E+00 | 0.0000E+00 | 0.0000E+00 | −2.7488E−02 | 0.0000E+00 | 0.0000E+00 |
| coefficient (L) | | | | | | |
| 24th order | 0.0000E+00 | 0.0000E+00 | 0.0000E+00 | 6.2033E−03 | 0.0000E+00 | 0.0000E+00 |
| coefficient (M) | | | | | | |
| 26th order | 0.0000E+00 | 0.0000E+00 | 0.0000E+00 | −9.3573E−04 | 0.0000E+00 | 0.0000E+00 |
| coefficient (N) | | | | | | |
| 28th order | 0.0000E+00 | 0.0000E+00 | 0.0000E+00 | 8.4556E−05 | 0.0000E+00 | 0.0000E+00 |
| coefficient (O) | | | | | | |
| 30th order | 0.0000E+00 | 0.0000E+00 | 0.0000E+00 | −3.4571E−06 | 0.0000E+00 | 0.0000E+00 |
| coefficient (P) | | | | | | |

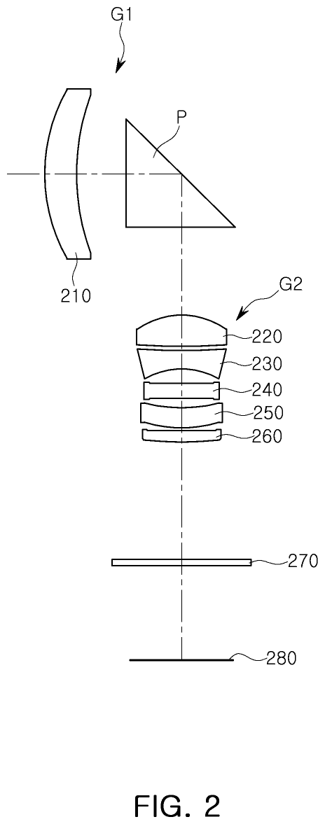

FIG. 2 is a configuration diagram illustrating an optical imaging system according to a second embodiment. The optical imaging system, according to the second embodiment may be described with reference to FIG. 2.

The optical imaging system, according to the second embodiment, may include a first lens group G1 and a second lens group G2. The optical imaging system may include a reflective member P disposed between the first lens group G1 and the second lens group G2.

The first lens group G1 may include a first lens 210, and the second lens group G2 may include a second lens 220, a third lens 230, a fourth lens 240, a fifth lens 250 and a sixth lens 260, in order from an object side.

Also, the optical imaging system may further include a filter 270 and an image sensor.

The optical imaging system, according to the second embodiment, may form a focus on an imaging plane 280. The imaging plane 280 may refer to the surface on which focus is formed by the optical imaging system. As an example, the imaging plane 280 may refer to one surface of the image sensor in which light is received.

The reflective member P may be implemented as a prism, or may be provided as a mirror.

Lens characteristics (radius of curvature, thickness of the lens or distance between lenses, refractive index, Abbe number, and focal length) of each lens are listed in Table 4.

TABLE 4

| Surface | | Radius of | Thickness or | Refractive | Abbe | Focal |
|---|---|---|---|---|---|---|
| No. | Elements | curvature | distance | index | number | length |
| S1 | First | 8.091 | 1.300 | 1.535 | 55.7 | 37.985 |
| | lens | | | | | |
| S2 | | 12.654 | 2.058 | | | |
| S3 | Prism | Infinity | 2.250 | 1.785 | 25.7 | |
| S4 | | Infinity | 2.250 | 1.785 | 25.7 | |
| S5 | | Infinity | 3.779 | | | |
| S6 | Second | 3.385 | 1.271 | 1.535 | 55.7 | 5.703 |
| | lens | | | | | |
| S7 | Aperture | −28.000 | 0.173 | | | |
| S8 | Third | −37.184 | 0.813 | 1.614 | 25.9 | −4.278 |
| | lens | | | | | |
| S9 | | 2.880 | 0.597 | | | |
| S10 | Fourth | −38.634 | 0.650 | 1.544 | 56.0 | −45.471 |
| | lens | | | | | |
| S11 | | 70.000 | 0.300 | | | |
| S12 | Fifth | −6.806 | 0.900 | 1.661 | 20.4 | 28.131 |
| | lens | | | | | |
| S13 | | −5.262 | 0.191 | | | |
| S14 | Sixth | 52.911 | 0.520 | 1.639 | 23.5 | 29.823 |
| | lens | | | | | |
| S15 | | −30.148 | 4.838 | | | |
| S16 | Filter | Infinity | 0.210 | 1.517 | 64.2 | |
| S17 | | Infinity | 3.624 | | | |
| S18 | Imaging | Infinity | | | | |
| | plane | | | | | |

TABLE 5

| | |
|---|---|
| Effective | Effective |
| radius | radius |
| in X-axis | in Y-axis |
| direction | direction |

| | |
|---|---|
| First | 3.480 |
| lens | 3.228 |

| | | |
|---|---|---|
| Second | 2.060 | 1.825 |
| lens | 1.922 | 1.825 |
| Third | 1.842 | 1.825 |

| | |
|---|---|
| lens | 1.520 |
| Fourth | 1.540 |
| lens | 1.480 |
| Fifth | 1.580 |

| | | |
|---|---|---|
| lens | 1.716 | 1.600 |
| Sixth | 1.750 | 1.600 |
| lens | 1.800 | 1.600 |

Table 5 may list an effective radius in the first axis (X-axis) direction and an effective radius in the second axis (Y-axis) direction of each of the first lens 210 to the sixth lens 260. The first axis (X-axis) direction and the second axis (Y-axis) direction may indicate two directions perpendicular to the optical axis of each lens, and perpendicular to each other.

The first lens 210 and the fourth lens 240 may have the same effective radius in the first axis (X-axis) direction and the same effective radius in the second axis (Y-axis) direction.

Effective radii in the first axis (X-axis) direction of an object-side surface and an image-side surface of the second lens 220 and the sixth lens 260 may be greater than effective radii in the second axis (Y-axis) direction.

The effective radius of an object-side surface of the third lens 230 in the first axis (X-axis) direction may be greater than the effective radius in the second axis (Y-axis) direction. An image-side surface of the third lens 230 may have the same effective radius in the first axis (X-axis) direction and the same effective radius in the second axis (Y-axis) direction.

An object-side surface of the fifth lens 250 may have the same effective radius in the first axis (X-axis) direction and the same effective radius in the second axis (Y-axis) direction. The effective radius in the first axis (X-axis) direction of an image-side surface of the fifth lens 250 may be greater than the effective radius in the second axis (Y-axis) direction.

In the second embodiment, the first lens group G1 may have positive refractive power entirely, and the second lens group G1 may have positive refractive power entirely.

The effective radius of an object-side surface of the first lens 210 of the first lens group G1 may be greater than the effective radius of an image-side surface.

The first lens 210 may have positive refractive power, an object-side surface of the first lens 210 may be convex, and an image-side surface of the first lens 210 may be concave.

The second lens 220 may have positive refractive power, and an object-side surface and an image-side surface of the second lens 220 may be convex.

The third lens 230 may have negative refractive power, and an object-side surface and an image-side surface of the third lens 230 may be concave.

The fourth lens 240 may have negative refractive power, and an object-side surface and an image-side surface of the fourth lens 240 may be concave.

The fifth lens 250 may have positive refractive power, an object-side surface of the fifth lens 250 may be concave, and an image-side surface of the fifth lens 250 may be convex.

The sixth lens 260 may have positive refractive power, and an object-side surface and an image-side surface of the sixth lens 260 may be convex.

An aperture may be disposed between the second lens 220 and the third lens 230.

Each surface of the first lens 210 to the sixth lens 260 may have an aspherical coefficient, as in Table 6. For example, an object-side surface and an image-side surface of each of the first lens 110 to the sixth lens 160 may be aspherical.

TABLE 6

| | S1 | S2 | S6 | S7 | S8 | S9 |
|---|---|---|---|---|---|---|
| Conic | −3.6757E+00 | 6.7495E+00 | 4.8518E−02 | 1.4570E+00 | −1.6593E+00 | −2.1408E−01 |
| constant (K) | | | | | | |
| 4th order | 1.9655E−03 | 1.2320E−03 | 1.6985E−03 | 4.6144E−04 | −6.5050E−03 | −7.4357E−03 |
| coefficient (A) | | | | | | |
| 6th order | −7.4080E−04 | −1.4653E−03 | −4.1752E−03 | 8.8763E−03 | 1.6227E−03 | −6.2937E−03 |
| coefficient (B) | | | | | | |
| 8th order | 6.5320E−04 | 1.6380E−03 | 1.1175E−02 | −2.9662E−02 | 2.7874E−02 | 4.3563E−02 |
| coefficient (C) | | | | | | |
| 10th order | −3.7723E−04 | −1.1900E−03 | −2.0345E−02 | 5.9302E−02 | −1.0557E−01 | −5.0278E−02 |
| coefficient (D) | | | | | | |
| 12th order | 1.5264E−04 | 5.9716E−04 | 2.5278E−02 | −7.2782E−02 | 2.2124E−01 | −1.0377E−01 |
| coefficient (E) | | | | | | |
| 14th order | −4.4804E−05 | −2.1433E−04 | −2.1795E−02 | 5.5351E−02 | −3.0116E−01 | 4.6579E−01 |
| coefficient (F) | | | | | | |
| 16th order | 9.7300E−06 | 5.6171E−05 | 1.3173E−02 | −2.4047E−02 | 2.8182E−01 | −8.2510E−01 |
| coefficient (G) | | | | | | |
| 18th order | −1.5731E−06 | −1.0842E−05 | −5.5878E−03 | 3.1481E−03 | −1.8614E−01 | 8.9495E−01 |
| coefficient (H) | | | | | | |
| 20th order | 1.8834E−07 | 1.5377E−06 | 1.6457E−03 | 2.6432E−03 | 8.7488E−02 | −6.5264E−01 |
| coefficient (J) | | | | | | |
| 22nd order | −1.6423E−08 | −1.5807E−07 | −3.2706E−04 | −1.7934E−03 | −2.9065E−02 | 3.2784E−01 |
| coefficient (L) | | | | | | |
| 24th order | 1.0107E−09 | 1.1441E−08 | 4.1228E−05 | 5.4441E−04 | 6.6640E−03 | −1.1229E−01 |
| coefficient (M) | | | | | | |
| 26th order | −4.1495E−11 | −5.5197E−10 | −2.8494E−06 | −9.3560E−05 | −1.0026E−03 | 2.5092E−02 |
| coefficient (N) | | | | | | |
| 28th order | 1.0177E−12 | 1.5913E−11 | 6.1270E−08 | 8.8110E−06 | 8.9026E−05 | −3.3015E−03 |
| coefficient (O) | | | | | | |
| 30th order | −1.1259E−14 | −2.0716E−13 | 2.2816E−09 | −3.5508E−07 | −3.5358E−06 | 1.9416E−04 |
| coefficient (P) | | | | | | |
| | S10 | S11 | S12 | S13 | S14 | S15 |
| Conic | 1.2026E+01 | 1.6288E+01 | 2.2674E−01 | −3.5865E−02 | −1.2964E+01 | −4.9327E+00 |
| constant (K) | | | | | | |
| 4th order | 9.3604E−03 | 1.2869E−02 | 3.7655E−03 | 5.2317E−03 | −5.8055E−03 | −9.2496E−03 |
| coefficient (A) | | | | | | |
| 6th order | −5.0859E−02 | −2.2589E−02 | −4.0913E−02 | −3.0602E−02 | −4.5316E−03 | −4.5439E−04 |
| coefficient (B) | | | | | | |
| 8th order | 2.5240E−01 | 4.4174E−02 | 1.9774E−01 | 1.1035E−01 | 1.4094E−02 | −4.4041E−05 |
| coefficient (C) | | | | | | |
| 10th order | −8.4142E−01 | −4.4108E−02 | −6.8335E−01 | −2.5140E−01 | −2.7075E−02 | −2.0246E−06 |
| coefficient (D) | | | | | | |
| 12th order | 2.0035E+00 | 3.0503E−03 | 1.6693E+00 | 3.9006E−01 | 3.2744E−02 | −1.6332E−06 |
| coefficient (E) | | | | | | |
| 14th order | −3.4869E+00 | 6.7230E−02 | −2.8989E+00 | −4.2929E−01 | −2.6591E−02 | −6.5104E−07 |
| coefficient (F) | | | | | | |
| 16th order | 4.4585E+00 | −1.3680E−01 | 3.6323E+00 | 3.4401E−01 | 1.4995E−02 | 4.7813E−07 |
| coefficient (G) | | | | | | |
| 18th order | −4.1884E+00 | 1.6755E−01 | −3.3149E+00 | −2.0335E−01 | −5.9851E−03 | −2.9719E−08 |
| coefficient (H) | | | | | | |
| 20th order | 2.8750E+00 | −1.4156E−01 | 2.2018E+00 | 8.8703E−02 | 1.7025E−03 | −1.6286E−09 |
| coefficient (J) | | | | | | |
| 22nd order | −1.4217E+00 | 8.3554E−02 | −1.0511E+00 | −2.8188E−02 | −3.4295E−04 | 1.0252E−10 |
| coefficient (L) | | | | | | |
| 24th order | 4.9241E−01 | −3.3826E−02 | 3.5054E−01 | 6.3380E−03 | 4.7806E−05 | 2.2750E−11 |
| coefficient (M) | | | | | | |
| 26th order | −1.1322E−01 | 8.9648E−03 | −7.7355E−02 | −9.5409E−04 | −4.3862E−06 | 3.3391E−12 |
| coefficient (N) | | | | | | |
| 28th order | 1.5510E−02 | −1.4031E−03 | 1.0129E−02 | 8.6136E−05 | 2.3830E−07 | −3.4368E−15 |
| coefficient (O) | | | | | | |
| 30th order | −9.5701E−04 | 9.8398E−05 | −5.9491E−04 | −3.5212E−06 | −5.8039E−09 | −2.9992E−13 |
| coefficient (P) | | | | | | |

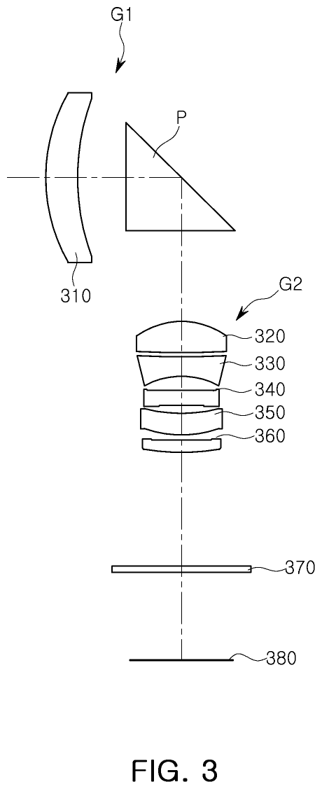

FIG. 3 is a configuration diagram illustrating an optical imaging system according to a third embodiment. The optical imaging system, according to the third embodiment, may be described with reference to FIG. 3.

The optical imaging system, according to the third embodiment, may include a first lens group G1 and a second lens group G2. The optical imaging system may include a reflective member P disposed between the first lens group G1 and the second lens group G2.

The first lens group G1 may include a first lens 310, and the second lens group G2 may include a second lens 320, a third lens 330, a fourth lens 340, a fifth lens 350 and a sixth lens 360, in order from an object side.

Also, the optical imaging system may further include a filter 370 and an image sensor.

The optical imaging system, according to the third embodiment, may form a focus on an imaging plane 380. The imaging plane 380 may refer to the surface on which focus is formed by the optical imaging system. As an example, the imaging plane 380 may refer to one surface of the image sensor in which light is received.

The reflective member P may be implemented as a prism, or may be provided as a mirror.

Lens characteristics (radius of curvature, thickness of the lens or distance between lenses, refractive index, Abbe number, and focal length) of each lens are listed in Table 7.

TABLE 7

| Surface | | Radius of | Thickness or | Refractive | Abbe | Focal |
|---|---|---|---|---|---|---|
| No. | Elements | curvature | distance | index | number | length |
| S1 | First | 8.090 | 1.300 | 1.535 | 55.7 | 37.988 |
| | lens | | | | | |
| S2 | | 12.653 | 2.041 | | | |
| S3 | Prism | Infinity | 2.250 | 1.785 | 25.7 | |
| S4 | | Infinity | 2.250 | 1.785 | 25.7 | |
| S5 | | Infinity | 3.761 | | | |
| S6 | Second | 3.385 | 1.273 | 1.535 | 55.7 | 5.702 |
| | lens | | | | | |
| S7 | | −28.000 | 0.172 | | | |
| S8 | Third | −37.199 | 0.815 | 1.614 | 25.9 | −4.276 |
| | lens | | | | | |
| S9 | | 2.878 | 0.591 | | | |
| S10 | Fourth | −39.749 | 0.650 | 1.544 | 56.0 | −45.615 |
| | lens | | | | | |
| S11 | | 67.189 | 0.300 | | | |
| S12 | Fifth | −6.752 | 0.900 | 1.661 | 20.4 | 28.561 |
| | lens | | | | | |
| S13 | | −5.254 | 0.188 | | | |
| S14 | Sixth | 52.002 | 0.523 | 1.639 | 23.5 | 29.544 |
| | lens | | | | | |
| S15 | | −30.000 | 0.000 | | | |
| S16 | Filter | Infinity | 0.210 | 1.517 | 64.2 | |
| S17 | | Infinity | 3.638 | | | |
| S18 | Imaging | Infinity | | | | |
| | plane | | | | | |

TABLE 8

| | |
|---|---|
| Effective | Effective |
| radius | radius |
| in X-axis | in Y-axis |
| direction | direction |

| | |
|---|---|
| First | 3.480 |
| lens | 3.228 |

| | | |
|---|---|---|
| Second | 2.060 | 1.825 |
| lens | 1.922 | 1.825 |

| | |
|---|---|
| Third | 1.834 |
| lens | 1.503 |
| Fourth | 1.489 |
| lens | 1.480 |
| Fifth | 1.494 |

| | | |
|---|---|---|
| lens | 1.669 | 1.600 |
| Sixth | 1.732 | 1.600 |
| lens | 1.800 | 1.600 |

Table 8 may list an effective radius in the first axis (X-axis) direction and an effective radius in the second axis (Y-axis) direction of each of the first lens 310 to the sixth lens 360. The first axis (X-axis) direction and the second axis (Y-axis) direction may indicate two directions perpendicular to the optical axis of each lens, and perpendicular to each other.

The first lens 310, the third lens 330 and the fourth lens 340 may have the same effective radius in the first axis (X-axis) direction and the same effective radius in the second axis (Y-axis) direction.

Effective radii in the first axis (X-axis) direction of an object-side surface and an image-side surface of each of the second lens 320 and the sixth lens 360 may be greater than effective radii in the second axis (Y-axis) direction.

An object-side surface of the fifth lens 350 may have the same effective radius in the first axis (X-axis) direction and the same effective radius in the second axis (Y-axis) direction. The effective radius in the first axis (X-axis) direction of an image-side surface of the fifth lens 350 may be greater than the effective radius in the second axis (Y-axis) direction.

In the third embodiment, the first lens group G1 may have positive refractive power entirely, and the second lens group G1 may have positive refractive power entirely.

The effective radius of an object-side surface of the first lens 310 of the first lens group G1 may be greater than the effective radius of an image-side surface.

The first lens 310 may have positive refractive power, an object-side surface of the first lens 310 may be convex, and an image-side surface of the first lens 310 may be concave.

The second lens 320 may have positive refractive power, and an object-side surface and an image-side surface of the second lens 320 may be convex.

The third lens 330 may have negative refractive power, and an object-side surface and an image-side surface of the third lens 330 may be concave.

The fourth lens 340 may have negative refractive power, and an object-side surface and an image-side surface of the fourth lens 340 may be concave.

The fifth lens 350 may have positive refractive power, an object-side surface of the fifth lens 350 may be concave, and an image-side surface of the fifth lens 350 may be convex.

The sixth lens 360 may have positive refractive power, and an object-side surface and an image-side surface of the sixth lens 360 may be convex.

An aperture may be disposed between an emitting surface of the reflective member P and the second lens 320.

Each surface of the first lens 310 to the sixth lens 360 may have an aspherical coefficient, as in Table 9. For example, an object-side surface and an image-side surface of the first lens 310 to the sixth lens 360 may be aspherical.

TABLE 9

| | S1 | S2 | S6 | S7 | S8 | S9 |
|---|---|---|---|---|---|---|
| Conic | −3.6761E+00 | 6.7496E+00 | 4.8901E−02 | 1.7534E+00 | −2.3696E+00 | −2.1470E−01 |
| constant (K) | | | | | | |
| 4th order | 1.9637E−03 | 1.2320E−03 | 1.3915E−03 | 3.9459E−04 | −6.3495E−03 | −7.3661E−03 |
| coefficient (A) | | | | | | |
| 6th order | −7.2950E−04 | −1.4562E−03 | −2.9169E−03 | 9.4847E−03 | 9.6151E−04 | −5.3889E−03 |
| coefficient (B) | | | | | | |
| 8th order | 6.3127E−04 | 1.6193E−03 | 8.5888E−03 | −3.1486E−02 | 2.8878E−02 | 3.6412E−02 |
| coefficient (C) | | | | | | |
| 10th order | −3.5648E−04 | −1.1730E−03 | −1.7098E−02 | 6.2338E−02 | −1.0588E−01 | −2.9502E−02 |
| coefficient (D) | | | | | | |
| 12th order | 1.4075E−04 | 5.8775E−04 | 2.2606E−02 | −7.5954E−02 | 2.1976E−01 | −1.3368E−01 |
| coefficient (E) | | | | | | |
| 14th order | −4.0277E−05 | −2.1074E−04 | −2.0291E−02 | 5.7556E−02 | −2.9792E−01 | 4.8374E−01 |
| coefficient (F) | | | | | | |
| 16th order | 8.5339E−06 | 5.5171E−05 | 1.2578E−02 | −2.5097E−02 | 2.7812E−01 | −8.1457E−01 |
| coefficient (G) | | | | | | |
| 18th order | −1.3488E−06 | −1.0633E−05 | −5.4206E−03 | 3.4893E−03 | −1.8334E−01 | 8.6336E−01 |
| coefficient (H) | | | | | | |
| 20th order | 1.5826E−07 | 1.5048E−06 | 1.6123E−03 | 2.5715E−03 | 8.6023E−02 | −6.2107E−01 |
| coefficient (J) | | | | | | |
| 22nd order | −1.3560E−08 | −1.5424E−07 | −3.2236E−04 | −1.7857E−03 | −2.8530E−02 | 3.0901E−01 |
| coefficient (L) | | | | | | |
| 24th order | 8.2176E−10 | 1.1120E−08 | 4.0770E−05 | 5.4472E−04 | 6.5302E−03 | −1.0503E−01 |
| coefficient (M) | | | | | | |
| 26th order | −3.3281E−11 | −5.3396E−10 | −2.8189E−06 | −9.3789E−05 | −9.8077E−04 | 2.3314E−02 |
| coefficient (N) | | | | | | |
| 28th order | 8.0619E−13 | 1.5308E−11 | 5.9906E−08 | 8.8408E−06 | 8.6944E−05 | −3.0485E−03 |
| coefficient (O) | | | | | | |
| 30th order | −8.8174E−15 | −1.9800E−13 | 2.3167E−09 | −3.5649E−07 | −3.4473E−06 | 1.7822E−04 |
| coefficient (P) | | | | | | |
| | S10 | S11 | S12 | S13 | S14 | S15 |
| Conic | 1.0979E+01 | 1.5760E+01 | 2.2917E−01 | −3.5495E−02 | −1.3255E+01 | −4.5151E+00 |
| constant (K) | | | | | | |
| 4th order | 8.2303E−03 | 1.2880E−02 | 4.5659E−03 | 5.2659E−03 | −5.9437E−03 | −9.5637E−03 |
| coefficient (A) | | | | | | |
| 6th order | −3.9739E−02 | −2.2887E−02 | −4.5861E−02 | −3.1634E−02 | −2.8981E−03 | 1.5570E−03 |
| coefficient (B) | | | | | | |
| 8th order | 2.0160E−01 | 4.7167E−02 | 2.0570E−01 | 1.1307E−01 | 9.0083E−03 | −5.2953E−03 |
| coefficient (C) | | | | | | |
| 10th order | −7.0184E−01 | −5.5028E−02 | −6.6253E−01 | −2.5362E−01 | −1.8483E−02 | 7.3301E−03 |
| coefficient (D) | | | | | | |
| 12th order | 1.7511E+00 | 2.4592E−02 | 1.5471E+00 | 3.8872E−01 | 2.3476E−02 | −6.3024E−03 |
| coefficient (E) | | | | | | |
| 14th order | −3.1751E+00 | 4.0669E−02 | −2.6221E+00 | −4.2459E−01 | −1.9839E−02 | 3.4790E−03 |
| coefficient (F) | | | | | | |
| 16th order | 4.1957E+00 | −1.1470E−01 | 3.2483E+00 | 3.3887E−01 | 1.1586E−02 | −1.2186E−03 |
| coefficient (G) | | | | | | |
| 18th order | −4.0443E+00 | 1.5453E−01 | −2.9529E+00 | −1.9994E−01 | −4.7750E−03 | 2.4294E−04 |
| coefficient (H) | | | | | | |
| 20th order | 2.8329E+00 | −1.3595E−01 | 1.9614E+00 | 8.7147E−02 | 1.3995E−03 | −1.1678E−05 |
| coefficient (J) | | | | | | |
| 22nd order | −1.4236E+00 | 8.1792E−02 | −9.3806E−01 | −2.7682E−02 | −2.8988E−04 | −7.2397E−06 |
| coefficient (L) | | | | | | |
| 24th order | 4.9950E−01 | −3.3448E−02 | 3.1361E−01 | 6.2219E−03 | 4.1463E−05 | 2.1116E−06 |
| coefficient (M) | | | | | | |
| 26th order | −1.1606E−01 | 8.9196E−03 | −6.9377E−02 | −9.3611E−04 | −3.8953E−06 | −2.7636E−07 |
| coefficient (N) | | | | | | |
| 28th order | 1.6031E−02 | −1.4022E−03 | 9.1040E−03 | 8.4451E−05 | 2.1627E−07 | 1.8638E−08 |
| coefficient (O) | | | | | | |
| 30th order | −9.9586E−04 | 9.8671E−05 | −5.3553E−04 | −3.4492E−06 | −5.3712E−09 | −5.2485E−10 |
| coefficient (P) | | | | | | |

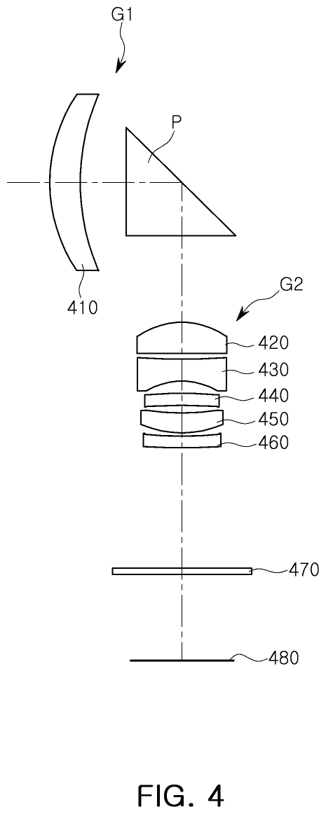

FIG. 4 is a configuration diagram illustrating an optical imaging system according to a fourth embodiment. The optical imaging system, according to the fourth embodiment, may be described with reference to FIG. 4.

An optical imaging system, according to the fourth embodiment, may include a first lens group G1 and a second lens group G2. The optical imaging system may include a reflective member P disposed between the first lens group G1 and the second lens group G2.

The first lens group G1 may include a first lens 410, and the second lens group G2 may include a second lens 420, a third lens 430, a fourth lens 440, a fifth lens 450 and a sixth lens 460, in order from an object side.

Also, the optical imaging system may further include a filter 470 and an image sensor.

The optical imaging system, according to the fourth embodiment, may form a focus on an imaging plane 480. The imaging plane 480 may refer to the surface on which focus is formed by the optical imaging system. As an example, the imaging plane 480 may refer to one surface of the image sensor in which light is received.

The reflective member P may be implemented as a prism, or may be provided as a mirror.

Lens characteristics (radius of curvature, thickness of the lens or distance between lenses, refractive index, Abbe number, and focal length) of each lens are listed in Table 10.

TABLE 10

| Surface | | Radius of | Thickness or | Refractive | Abbe | Focal |
|---|---|---|---|---|---|---|
| No. | Elements | curvature | distance | index | number | length |
| S1 | First | 7.775 | 1.200 | 1.535 | 55.7 | 37.5 |
| | lens | | | | | |
| S2 | | 11.979 | 2.000 | | | |
| S3 | Prism | Infinity | 2.250 | 1.785 | 25.7 | |
| S4 | | Infinity | 2.250 | 1.785 | 25.7 | |
| S5 | | Infinity | 3.559 | | | |
| S6 | Second | 3.414 | 1.285 | 1.535 | 55.7 | 5.913 |
| | lens | | | | | |
| S7 | | −39.711 | 0.270 | | | |
| S8 | Third | −10.000 | 0.876 | 1.614 | 25.9 | −3.375 |
| | lens | | | | | |
| S9 | | 2.735 | 0.479 | | | |
| S10 | Fourth | 16.409 | 0.532 | 1.544 | 56.0 | 56.624 |
| | lens | | | | | |
| S11 | | 34.545 | 0.284 | | | |
| S12 | Fifth | −91.199 | 0.852 | 1.661 | 20.4 | 7.884 |
| | lens | | | | | |
| S13 | | −5.000 | 0.100 | | | |
| S14 | Sixth | −19.935 | 0.500 | 1.639 | 23.5 | −28.320 |
| | lens | | | | | |
| S15 | | 222.685 | 4.838 | | | |
| S16 | Filter | Infinity | 0.210 | 1.517 | 64.2 | |
| S17 | | Infinity | 3.900 | | | |
| S18 | Imaging | Infinity | | | | |
| | plane | | | | | |

TABLE 11

| | |
|---|---|
| Effective | Effective |
| radius | radius |
| in X-axis | in Y-axis |
| direction | direction |

| | |
|---|---|
| First | 3.480 |
| lens | 3.251 |

| | | |
|---|---|---|
| Second | 2.080 | 1.825 |
| lens | 1.921 | 1.825 |

| | |
|---|---|
| Third | 1.829 |
| lens | 1.473 |
| Fourth | 1.498 |
| lens | 1.545 |
| Fifth | 1.573 |

| | | |
|---|---|---|
| lens | 1.691 | 1.600 |
| Sixth | 1.708 | 1.600 |
| lens | 1.750 | 1.600 |

Table 11 may list an effective radius in the first axis (X-axis) direction and an effective radius in the second axis (Y-axis) direction of each of the first lens 410 to the sixth lens 460. The first axis (X-axis) direction and the second axis (Y-axis) direction may indicate two directions perpendicular to the optical axis of each lens, and perpendicular to each other.

The first lens 410, the third lens 430 and the fourth lens 440 may have the same effective radius in the first axis (X-axis) direction and the same effective radius in the second axis (Y-axis) direction.

Effective radii of an object-side surface and an image-side surface of each of the second lens 420 and the sixth lens 460 in the first axis (X-axis) direction may be greater than effective radii in the second axis (Y-axis) direction.

An object-side surface of the fifth lens 450 may have the same effective radius in the first axis (X-axis) direction and the same effective radius in the second axis (Y-axis) direction. The effective radius in the first axis (X-axis) direction of an image-side surface of the fifth lens 450 may be greater than the effective radius in the second axis (Y-axis) direction.

In the fourth embodiment, the first lens group G1 may have positive refractive power entirely, and the second lens group G1 may have positive refractive power entirely.

The effective radius of an object-side surface of the first lens 410 of the first lens group G1 may be greater than the effective radius of an image-side surface.

The first lens 410 may have positive refractive power, an object-side surface of the first lens 410 may be convex, and an image-side surface of the first lens 410 may be concave.

The second lens 420 may have positive refractive power, and an object-side surface and an image-side surface of the second lens 420 may be convex.

The third lens 430 may have negative refractive power, and an object-side surface and an image-side surface of the third lens 430 may be concave.

The fourth lens 440 may have positive refractive power, an object-side surface of the fourth lens 440 may be convex, and an image-side surface of the fourth lens 440 may be concave.

The fifth lens 450 may have positive refractive power, an object-side surface of the fifth lens 450 may be concave, and an image-side surface of the fifth lens 450 may be convex.

The sixth lens 460 may have negative refractive power, and an object-side surface and an image-side surface of the sixth lens 460 may be concave.

An aperture may be disposed between an emitting surface of the reflective member P and the second lens 420.

Each surface of the first lens 410 to the sixth lens 460 may have an aspherical coefficient, as in Table 12. For example, an object-side surface and an image-side surface of the first lens 410 to the sixth lens 460 may be aspherical.

TABLE 12

| | S1 | S2 | S6 | S7 | S8 | S9 |
|---|---|---|---|---|---|---|
| Conic | −3.8171E+00 | 6.4417E+00 | 7.6369E−01 | 3.7067E−02 | −1.0000E+01 | −1.2147E−01 |
| constant (K) | | | | | | |
| 4th order | 1.3459E−03 | −1.7787E−05 | −2.2522E−03 | 6.6662E−03 | 2.6572E−03 | −1.0878E−02 |
| coefficient (A) | | | | | | |
| 6th order | 1.5356E−04 | 2.7561E−04 | 4.8892E−04 | −1.2018E−03 | 8.1973E−04 | 2.7164E−03 |
| coefficient (B) | | | | | | |
| 8th order | −6.8484E−05 | −1.4604E−04 | −1.1526E−03 | −6.1073E−04 | 4.4272E−05 | 3.9008E−03 |
| coefficient (C) | | | | | | |
| 10th order | 1.9840E−05 | 4.9298E−05 | 6.4565E−04 | 2.1925E−04 | −3.4256E−05 | −4.1546E−03 |
| coefficient (D) | | | | | | |
| 12th order | −3.5074E−06 | −1.0276E−05 | −2.0548E−04 | 4.0166E−04 | 0.0000E+00 | 2.0918E−03 |
| coefficient (E) | | | | | | |
| 14th order | 3.8905E−07 | 1.3410E−06 | 3.2193E−05 | −3.6838E−04 | 0.0000E+00 | −4.8072E−04 |
| coefficient (F) | | | | | | |
| 16th order | −2.6205E−08 | −1.0617E−07 | −2.1005E−06 | 1.2793E−04 | 0.0000E+00 | 4.1948E−05 |
| coefficient (G) | | | | | | |
| 18th order | 9.7956E−10 | 4.6581E−09 | 0.0000E+00 | −2.0779E−05 | 0.0000E+00 | 0.0000E+00 |
| coefficient (H) | | | | | | |
| 20th order | −1.5529E−11 | −8.6624E−11 | 0.0000E+00 | 1.3141E−06 | 0.0000E+00 | 0.0000E+00 |
| coefficient (J) | | | | | | |
| | S10 | S11 | S12 | S13 | S14 | S15 |
| Conic | 0.0000E+00 | 0.0000E+00 | −1.0000E+01 | −2.4727E−01 | 0.0000E+00 | −1.0000E+01 |
| constant (K) | | | | | | |
| 4th order | 6.5767E−04 | 6.3858E−03 | −9.3531E−03 | −1.6558E−03 | −1.0051E−03 | −8.0953E−03 |
| coefficient (A) | | | | | | |
| 6th order | −7.9051E−04 | −7.3858E−04 | −3.4499E−04 | −1.2916E−04 | 2.3320E−05 | 1.2828E−04 |
| coefficient (B) | | | | | | |
| 8th order | −2.6734E−05 | −2.2621E−04 | 8.0429E−04 | −5.6001E−05 | −7.6226E−05 | 4.5237E−05 |
| coefficient (C) | | | | | | |
| 10th order | 9.4033E−05 | 2.2439E−05 | −7.1065E−04 | −1.5453E−04 | 2.1388E−05 | 5.3378E−06 |
| coefficient (D) | | | | | | |
| 12th order | 0.0000E+00 | 0.0000E+00 | 1.4394E−04 | 2.8716E−05 | −6.3747E−06 | −4.6193E−06 |
| coefficient (E) | | | | | | |
| 14th order | 0.0000E+00 | 0.0000E+00 | 0.0000E+00 | 0.0000E+00 | 0.0000E+00 | 0.0000E+00 |
| coefficient (F) | | | | | | |
| 16th order | 0.0000E+00 | 0.0000E+00 | 0.0000E+00 | 0.0000E+00 | 0.0000E+00 | 0.0000E+00 |
| coefficient (G) | | | | | | |
| 18th order | 0.0000E+00 | 0.0000E+00 | 0.0000E+00 | 0.0000E+00 | 0.0000E+00 | 0.0000E+00 |
| coefficient (H) | | | | | | |
| 20th order | 0.0000E+00 | 0.0000E+00 | 0.0000E+00 | 0.0000E+00 | 0.0000E+00 | 0.0000E+00 |
| coefficient (J) | | | | | | |

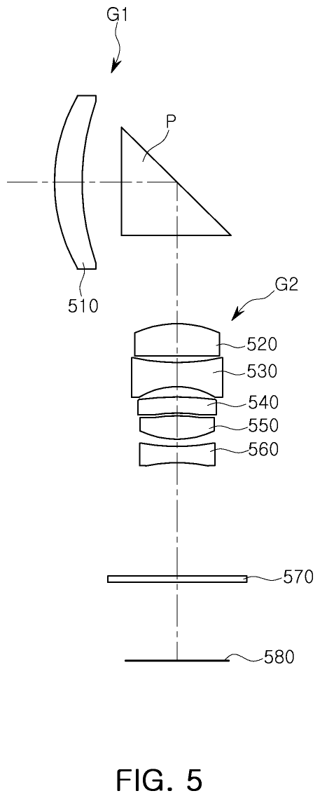

FIG. 5 is a configuration diagram illustrating an optical imaging system according to a fifth embodiment. The optical imaging system, according to the fifth embodiment, may be described with reference to FIG. 5.

An optical imaging system, according to the fifth embodiment, may include a first lens group G1 and a second lens group G2. The optical imaging system may include a reflective member P disposed between the first lens group G1 and the second lens group G2.

The first lens group G1 may include a first lens 510, and the second lens group G2 may include a second lens 520, a third lens 530, a fourth lens 540, a fifth lens 550 and a sixth lens 560, in order from an object side.

Also, the optical imaging system may further include a filter 570 and an image sensor.

The optical imaging system according to the fifth embodiment may form a focus on an imaging plane 580. The imaging plane 580 may refer to the surface on which focus is formed by the optical imaging system. As an example, the imaging plane 580 may refer to one surface of the image sensor in which light is received.

The reflective member P may be implemented as a prism, or may be provided as a mirror.

Lens characteristics (radius of curvature, thickness of the lens or distance between lenses, refractive index, Abbe number, and focal length) of each lens are listed in Table 13.

TABLE 13

| Surface | | Radius of | Thickness or | Refractive | Abbe | Focal |
|---|---|---|---|---|---|---|
| No. | Elements | curvature | distance | index | number | length |
| S1 | First | 9.042 | 1.200 | 1.535 | 55.7 | 37 |
| | lens | | | | | |
| S2 | | 15.821 | 1.800 | | | |
| S3 | Prism | Infinity | 2.250 | 1.714 | 29.5 | |
| S4 | | Infinity | 2.250 | 1.714 | 29.5 | |
| S5 | | Infinity | 3.792 | | | |
| S6 | Second | 4.205 | 1.425 | 1.535 | 55.7 | 7.174 |
| | lens | | | | | |
| S7 | Aperture | −40.627 | 0.284 | | | |
| S8 | Third | −8.722 | 1.066 | 1.639 | 23.5 | −3.246 |
| | lens | | | | | |
| S9 | | 2.890 | 0.418 | | | |
| S10 | Fourth | 9.282 | 0.726 | 1.544 | 56.0 | 19.560 |
| | lens | | | | | |
| S11 | | 68.684 | 0.104 | | | |
| S12 | Fifth | 11.573 | 1.000 | 1.661 | 20.4 | 4.315 |
| | lens | | | | | |
| S13 | | −3.708 | 0.320 | | | |
| S14 | Sixth | −11.398 | 0.700 | 1.639 | 23.5 | −6.753 |
| | lens | | | | | |
| S15 | | 7.229 | 4.838 | | | |
| S16 | filter | Infinity | 0.210 | 1.517 | 64.2 | |
| S17 | | Infinity | 3.370 | | | |
| S18 | imaging | Infinity | | | | |
| | plane | | | | | |

TABLE 14

| | |
|---|---|
| Effective | Effective |
| radius | radius |
| in X-axis | in Y-axis |
| direction | direction |

| | |
|---|---|
| First | 3.750 |
| lens | 3.527 |

| | | |
|---|---|---|
| Second | 2.547 | 1.825 |
| lens | 2.012 | 1.825 |
| Third | 1.958 | 1.825 |

| | |
|---|---|
| lens | 1.615 |
| Fourth | 1.660 |
| lens | 1.647 |
| Fifth | 1.650 |

| | | |
|---|---|---|
| lens | 1.670 | 1.600 |
| Sixth | 1.604 | 1.600 |
| lens | 1.630 | 1.600 |

Table 14 may list an effective radius in the first axis (X-axis) direction and an effective radius in the second axis (Y-axis) direction of each of the first lens 510 to the sixth lens 560. The first axis (X-axis) direction and the second axis (Y-axis) direction may indicate two directions perpendicular to the optical axis of each lens, and perpendicular to each other.

The first lens 510 and the fourth lens 540 may have the same effective radius in the first axis (X-axis) direction and the same effective radius in the second axis (Y-axis) direction.

Effective radii in the first axis (X-axis) direction of an object-side surface and an image-side surface of each of the second lens 520 and the sixth lens 560 may be greater than effective radii in the second axis (Y-axis) direction.

The effective radius of an object-side surface of the third lens 530 in the first axis (X-axis) direction may be greater than the effective radius in the second axis (Y-axis) direction. An image-side surface of the third lens 530 may have the same effective radius in the first axis (X-axis) direction and the same effective radius in the second axis (Y-axis) direction.

An object-side surface of the fifth lens 550 may have the same effective radius in the first axis (X-axis) direction and the same effective radius in the second axis (Y-axis) direction. The effective radius in the first axis (X-axis) direction of an image-side surface of the fifth lens 550 may be greater than the effective radius in the second axis (Y-axis) direction.

In the fifth embodiment, the first lens group G1 may have positive refractive power entirely, and the second lens group G1 may have positive refractive power entirely.

The effective radius of an object-side surface of the first lens 510 of the first lens group G1 may be greater than the effective radius of an image-side surface.

The first lens 510 may have positive refractive power, an object-side surface of the first lens 510 may be convex, and an image-side surface of the first lens 510 may be concave.

The second lens 520 may have positive refractive power, and an object-side surface and an image-side surface of the second lens 520 may be convex.

The third lens 530 may have negative refractive power, and an object-side surface and an image-side surface of the third lens 530 may be concave.

The fourth lens 540 may have positive refractive power, an object-side surface of the fourth lens 540 may be convex, and an image-side surface of the fourth lens 540 may be concave.

The fifth lens 550 may have positive refractive power, and an object-side surface and an image-side surface of the fifth lens 550 may be convex.

The sixth lens 560 may have negative refractive power, and an object-side surface and an image-side surface of the sixth lens 560 may be concave.

An aperture may be disposed between the second lens 520 and the third lens 530.

Each surface of the first lens 510 to the sixth lens 560 may have an aspherical coefficient, as in Table 15. For example, an object-side surface and an image-side surface of each of the first lens 510 to the sixth lens 560 may be aspherical.

TABLE 15

| | S1 | S2 | S6 | S7 | S8 | S9 |
|---|---|---|---|---|---|---|
| Conic | −5.2323E+00 | 7.5180E+00 | 9.6125E−01 | 3.7067E−02 | 1.1513E−02 | −1.1431E+00 |
| constant (K) | | | | | | |
| 4th order | 1.8694E−03 | 1.2969E−03 | −6.9337E−05 | 1.0119E−02 | −9.9568E−05 | −1.6918E−02 |
| coefficient (A) | | | | | | |
| 6th order | −2.7190E−04 | −5.5098E−04 | 1.2037E−03 | 2.3256E−03 | 2.6601E−04 | 8.6434E−03 |
| coefficient (B) | | | | | | |
| 8th order | 1.0785E−04 | 2.5101E−04 | −1.4545E−03 | −8.9162E−03 | 4.9126E−05 | −1.2362E−04 |
| coefficient (C) | | | | | | |
| 10th order | −2.6169E−05 | −6.8677E−05 | 6.6760E−04 | 7.7167E−03 | −9.2659E−06 | −1.5074E−03 |
| coefficient (D) | | | | | | |
| 12th order | 3.9537E−06 | 1.1717E−05 | −1.5868E−04 | −3.8173E−03 | 0.0000E+00 | 7.5001E−04 |
| coefficient (E) | | | | | | |
| 14th order | −3.6929E−07 | −1.2455E−06 | 1.1549E−05 | 1.1729E−03 | 0.0000E+00 | −1.9586E−04 |
| coefficient (F) | | | | | | |
| 16th order | 2.0837E−08 | 8.0397E−08 | 2.6622E−06 | −2.1972E−04 | 0.0000E+00 | 2.6167E−05 |
| coefficient (G) | | | | | | |
| 18th order | −6.5093E−10 | −2.8846E−09 | −6.0416E−07 | 2.2667E−05 | 0.0000E+00 | 0.0000E+00 |
| coefficient (H) | | | | | | |
| 20th order | 8.6533E−12 | 4.4158E−11 | 3.2319E−08 | −9.7724E−07 | 0.0000E+00 | 0.0000E+00 |
| coefficient (J) | | | | | | |
| | S10 | S11 | S12 | S13 | S14 | S15 |
| Conic | 0.0000E+00 | 0.0000E+00 | −9.8817E+00 | −1.4173E+00 | 0.0000E+00 | −4.5178E+00 |
| constant (K) | | | | | | |
| 4th order | −2.0658E−04 | 2.4119E−03 | −6.0227E−03 | 1.5728E−03 | −4.3905E−03 | −1.2745E−02 |
| coefficient (A) | | | | | | |
| 6th order | 1.1035E−05 | −1.7085E−04 | 1.0175E−03 | −2.6494E−04 | −1.0662E−03 | 4.7998E−04 |
| coefficient (B) | | | | | | |
| 8th order | −1.5792E−04 | −1.2087E−04 | 1.3976E−03 | −1.9772E−04 | −3.4758E−04 | 2.1400E−04 |
| coefficient (C) | | | | | | |
| 10th order | −6.6055E−05 | −8.3326E−05 | −9.5454E−04 | −1.2635E−04 | 3.1244E−04 | 5.6750E−05 |
| coefficient (D) | | | | | | |
| 12th order | 0.0000E+00 | 0.0000E+00 | 1.1367E−04 | 1.2770E−05 | −4.3263E−05 | −1.7966E−05 |
| coefficient (E) | | | | | | |
| 14th order | 0.0000E+00 | 0.0000E+00 | 0.0000E+00 | 0.0000E+00 | 0.0000E+00 | 0.0000E+00 |
| coefficient (F) | | | | | | |
| 16th order | 0.0000E+00 | 0.0000E+00 | 0.0000E+00 | 0.0000E+00 | 0.0000E+00 | 0.0000E+00 |
| coefficient (G) | | | | | | |
| 18th order | 0.0000E+00 | 0.0000E+00 | 0.0000E+00 | 0.0000E+00 | 0.0000E+00 | 0.0000E+00 |
| coefficient (H) | | | | | | |
| 20th order | 0.0000E+00 | 0.0000E+00 | 0.0000E+00 | 0.0000E+00 | 0.0000E+00 | 0.0000E+00 |
| coefficient (J) | | | | | | |

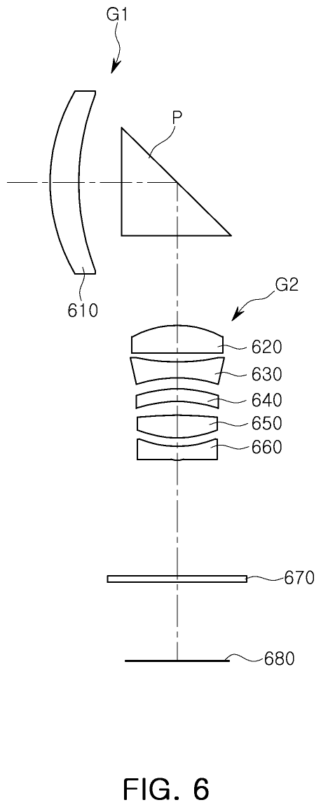

FIG. 6 is a configuration diagram illustrating an optical imaging system according to a sixth embodiment. An optical imaging system according to the sixth embodiment may be described with reference to FIG. 6.

The optical imaging system, according to the sixth embodiment, may include a first lens group G1 and a second lens group G2. The optical imaging system may include a reflective member P disposed between the first lens group G1 and the second lens group G2.

The first lens group G1 may include a first lens 610, and the second lens group G2 may include a second lens 620, a third lens 630, a fourth lens 640, a fifth lens 650 and a sixth lens 660, in order from an object side.

Also, the optical imaging system may further include a filter 670 and an image sensor.

The optical imaging system, according to the sixth embodiment, may form a focus on an imaging plane 680. The imaging plane 680 may refer to the surface on which focus is formed by the optical imaging system. As an example, the imaging plane 680 may refer to one surface of the image sensor in which light is received.

The reflective member P may be implemented as a prism, or may be provided as a mirror.

Lens characteristics (radius of curvature, thickness of the lens or distance between lenses, refractive index, Abbe number, and focal length) of each lens are listed in Table 16.

TABLE 16

| Surface | | Radius of | Thickness or | Refractive | Abbe | Focal |
|---|---|---|---|---|---|---|
| No. | Elements | curvature | distance | index | number | length |
| S1 | First | 8.902 | 1.200 | 1.535 | 55.7 | 37 |
| | lens | | | | | |
| S2 | | 15.366 | 1.800 | | | |
| S3 | Prism | Infinity | 2.250 | 1.785 | 25.7 | |
| S4 | | Infinity | 2.250 | 1.785 | 25.7 | |
| S5 | | Infinity | 3.600 | | | |
| S6 | Second | 3.850 | 1.141 | 1.535 | 55.7 | 6.592 |
| | lens | | | | | |
| S7 | Aperture | −39.546 | 0.377 | | | |
| S8 | Third | −7.498 | 0.619 | 1.639 | 23.5 | −4.270 |
| | lens | | | | | |
| S9 | | 4.500 | 0.472 | | | |
| S10 | Fourth | 5.182 | 0.500 | 1.544 | 56.0 | 127.89 |
| | lens | | | | | |
| S11 | | 5.407 | 0.562 | | | |
| S12 | Fifth | 10.709 | 0.955 | 1.661 | 20.4 | 4.784 |
| | lens | | | | | |
| S13 | | −4.396 | 0.350 | | | |
| S14 | Sixth | −3.942 | 0.549 | 1.639 | 23.5 | −6.820 |
| | lens | | | | | |
| S15 | | −39.699 | 4.838 | | | |
| S16 | Filter | Infinity | 0.210 | 1.517 | 64.2 | |
| S17 | | Infinity | 3.228 | | | |
| S18 | Imaging | Infinity | | | | |
| | plane | | | | | |

TABLE 17

| | |
|---|---|
| Effective | Effective |
| radius | radius |
| in X-axis | in Y-axis |
| direction | direction |

| | |
|---|---|
| First | 3.750 |
| lens | 3.522 |

| | | |
|---|---|---|
| Second | 2.120 | 1.825 |
| lens | 1.985 | 1.825 |
| Third | 1.906 | 1.825 |

| | |
|---|---|
| lens | 1.672 |
| Fourth | 1.650 |
| lens | 1.610 |

| | | |
|---|---|---|
| Fifth | 1.669 | 1.600 |
| lens | 1.700 | 1.600 |
| Sixth | 1.624 | 1.600 |
| lens | 1.660 | 1.600 |

Table 17 may list an effective radius in the first axis (X-axis) direction and an effective radius in the second axis (Y-axis) direction of each of the first lens 610 to the sixth lens 660. The first axis (X-axis) direction and the second axis (Y-axis) direction may indicate two directions perpendicular to the optical axis of each lens, and perpendicular to each other.

The first lens 610 and the fourth lens 640 may have the same effective radius in the first axis (X-axis) direction and the same effective radius in the second axis (Y-axis) direction. Effective radii in the first axis (X-axis) direction of an object-side surface and an image-side surface of each of the second lens 620, the fifth lens 650 and the sixth lens 660 may be greater than effective radii in the second axis (Y-axis) direction.

The effective radius of an object-side surface of the third lens 630 in the first axis (X-axis) direction may be greater than the effective radius in the second axis (Y-axis) direction. An image-side surface of the third lens 630 may have the same effective radius in the first axis (X-axis) direction and the same effective radius in the second axis (Y-axis) direction.

In the sixth embodiment, the first lens group G1 may have positive refractive power entirely, and the second lens group G1 may have positive refractive power entirely.

The effective radius of an object-side surface of the first lens 610 of the first lens group G1 may be greater than the effective radius of an image-side surface.

The first lens 610 may have positive refractive power, an object-side surface of the first lens 610 may be convex, and an image-side surface of the first lens 610 may be concave.

The second lens 620 may have positive refractive power, and an object-side surface and an image-side surface of the second lens 620 may be convex.

The third lens 630 may have negative refractive power, and an object-side surface and an image-side surface of the third lens 630 may be concave.

The fourth lens 640 may have positive refractive power, an object-side surface of the fourth lens 640 may be convex, and an image-side surface of the fourth lens 640 may be concave.

The fifth lens 650 may have positive refractive power, and an object-side surface and an image-side surface of the fifth lens 650 may be convex.

The sixth lens 660 may have negative refractive power, an object-side surface of the sixth lens 660 may be concave, and an image-side surface of the sixth lens 660 may be convex.

An aperture may be disposed between the second lens 620 and the third lens 630.

Each surface of the first lens 610 to the sixth lens 660 may have an aspherical coefficient, as in Table 18. For example, an object-side surface and an image-side surface of the first lens 610 to the fifth lens 650 may be aspherical, an object-side surface of the sixth lens 660 may be aspherical, and an image-side surface of the sixth lens 660 may be spherical.

TABLE 18

| | S1 | S2 | S6 | S7 | S8 | S9 |
|---|---|---|---|---|---|---|
| Conic | −5.0985E+00 | 6.8747E+00 | 9.3014E−01 | 3.7067E−02 | −2.7174E+00 | −9.6424E−01 |
| constant (K) | | | | | | |
| 4th order | 2.5172E−03 | 2.0580E−03 | 8.7137E−04 | 1.2391E−02 | 3.9442E−04 | −1.7125E−02 |
| coefficient (A) | | | | | | |
| 6th order | −9.4420E−04 | −1.4836E−03 | 3.8173E−04 | −7.6808E−03 | 3.2820E−04 | 1.4924E−02 |
| coefficient (B) | | | | | | |
| 8th order | 4.8662E−04 | 8.4822E−04 | −1.0974E−03 | 3.0475E−03 | 5.8052E−05 | −1.0560E−02 |
| coefficient (C) | | | | | | |
| 10th order | −1.4284E−04 | −2.7583E−04 | 6.5720E−04 | −6.2347E−04 | 1.1117E−05 | 6.2239E−03 |
| coefficient (D) | | | | | | |
| 12th order | 2.4683E−05 | 5.3091E−05 | −2.0436E−04 | −8.7573E−05 | 0.0000E+00 | −2.3117E−03 |
| coefficient (E) | | | | | | |
| 14th order | −2.5667E−06 | −6.1772E−06 | 3.1986E−05 | 1.0676E−04 | 0.0000E+00 | 4.7296E−04 |
| coefficient (F) | | | | | | |
| 16th order | 1.5825E−07 | 4.2746E−07 | −2.0184E−06 | −3.2694E−05 | 0.0000E+00 | −3.9245E−05 |
| coefficient (G) | | | | | | |
| 18th order | −5.3320E−09 | −1.6202E−08 | 0.0000E+00 | 4.7837E−06 | 0.0000E+00 | 0.0000E+00 |
| coefficient (H) | | | | | | |
| 20th order | 7.5667E−11 | 2.5911E−10 | 0.0000E+00 | −2.8530E−07 | 0.0000E+00 | 0.0000E+00 |
| coefficient (J) | | | | | | |

| | S10 | S11 | S12 | S13 | S14 |
|---|---|---|---|---|---|
| Conic | 0.0000E+00 | 0.0000E+00 | 9.5240E+00 | −1.5708E−01 | 0.0000E+00 |
| constant (K) | | | | | |
| 4th order | −1.8558E−03 | 5.0891E−03 | −5.5267E−03 | −6.0324E−04 | 3.5602E−03 |
| coefficient (A) | | | | | |
| 6th order | −8.3545E−05 | 7.6417E−04 | −1.9566E−04 | 9.9544E−05 | 4.6197E−04 |
| coefficient (B) | | | | | |
| 8th order | 1.1097E−04 | −1.7492E−04 | 1.3879E−03 | −5.0954E−05 | −7.3300E−04 |
| coefficient (C) | | | | | |
| 10th order | 4.0949E−05 | 7.3792E−05 | −7.6871E−04 | −1.0491E−04 | 3.3782E−04 |
| coefficient (D) | | | | | |
| 12th order | 0.0000E+00 | 0.0000E+00 | 1.1634E−04 | 2.0385E−05 | −4.5366E−05 |
| coefficient (E) | | | | | |
| 14th order | 0.0000E+00 | 0.0000E+00 | 0.0000E+00 | 0.0000E+00 | 0.0000E+00 |
| coefficient (F) | | | | | |
| 16th order | 0.0000E+00 | 0.0000E+00 | 0.0000E+00 | 0.0000E+00 | 0.0000E+00 |
| coefficient (G) | | | | | |
| 18th order | 0.0000E+00 | 0.0000E+00 | 0.0000E+00 | 0.0000E+00 | 0.0000E+00 |
| coefficient (H) | | | | | |
| 20th order | 0.0000E+00 | 0.0000E+00 | 0.0000E+00 | 0.0000E+00 | 0.0000E+00 |
| coefficient (J) | | | | | |

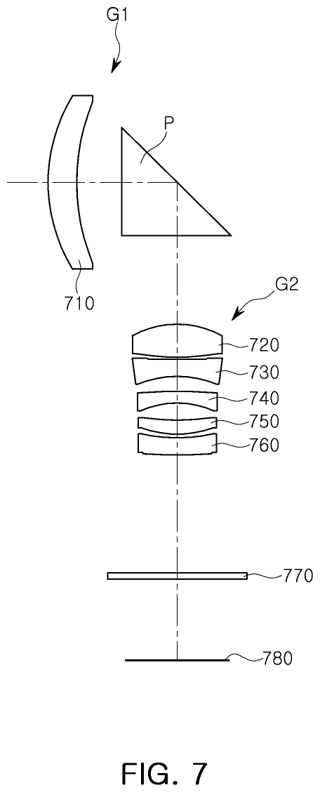

FIG. 7 is a configuration diagram illustrating an optical imaging system according to a seventh embodiment. The optical imaging system, according to the seventh embodiment, may be described with reference to FIG. 7.

The optical imaging system, according to the seventh embodiment, may include a first lens group G1 and a second lens group G2. The optical imaging system may include a reflective member P disposed between the first lens group G1 and the second lens group G2.

The first lens group G1 may include a first lens 710, and the second lens group G2 may include a second lens 720, a third lens 730, a fourth lens 740, a fifth lens 750 and a sixth lens 760, in order from an object side.

Also, the optical imaging system may further include a filter 770 and an image sensor.

The optical imaging system, according to the seventh embodiment, may form a focus on an imaging plane 780. The imaging plane 780 may refer to the surface on which focus is formed by the optical imaging system. As an example, the imaging plane 780 may refer to one surface of the image sensor in which light is received.

The reflective member P may be implemented as a prism, or may be provided as a mirror.

Lens characteristics (radius of curvature, thickness of the lens or distance between lenses, refractive index, Abbe number, and focal length) of each lens are listed in Table 19.

TABLE 19

| Surface | | Radius of | Thickness or | Refractive | Abbe | Focal |
|---|---|---|---|---|---|---|
| No. | Elements | curvature | distance | index | number | length |
| S1 | First | 8.037 | 1.200 | 1.535 | 55.7 | 42.851 |
| | lens | | | | | |
| S2 | | 11.704 | 1.800 | | | |
| S3 | Prism | Infinity | 2.250 | 1.785 | 25.7 | |
| S4 | | Infinity | 2.250 | 1.785 | 25.7 | |
| S5 | | Infinity | 3.580 | | | |
| S6 | Second | 3.534 | 1.367 | 1.535 | 55.7 | 5.193 |
| | lens | | | | | |
| S7 | aperture | −11.445 | 0.082 | | | |
| S8 | Third | −21.815 | 0.702 | 1.639 | 23.5 | −5.824 |
| | lens | | | | | |
| S9 | | 4.600 | 0.603 | | | |
| S10 | Fourth | 43.136 | 0.494 | 1.544 | 56.0 | −9.432 |
| | lens | | | | | |
| S11 | | 4.585 | 0.669 | | | |
| S12 | Fifth | −34.582 | 0.614 | 1.661 | 20.4 | 8.652 |
| | lens | | | | | |
| S13 | | −4.990 | 0.123 | | | |
| S14 | Sixth | −11.829 | 0.700 | 1.639 | 23.5 | −22.955 |
| | lens | | | | | |
| S15 | | −60.000 | 4.838 | | | |
| S16 | filter | Infinity | 0.210 | 1.517 | 64.2 | |
| S17 | | Infinity | 3.317 | | | |
| S18 | imaging | Infinity | | | | |
| | plane | | | | | |

TABLE 20

| | |
|---|---|
| Effective | Effective |
| radius | radius |
| in X-axis | in Y-axis |
| direction | direction |

| | |
|---|---|
| First | 3.550 |
| lens | 3.308 |

| | | |
|---|---|---|
| Second | 2.220 | 1.825 |
| lens | 2.087 | 1.825 |
| Third | 1.988 | 1.825 |

| | |
|---|---|
| lens | 1.670 |
| Fourth | 1.632 |
| lens | 1.530 |
| Fifth | 1.559 |
| lens | 1.599 |
| Sixth | 1.584 |

| | | |
|---|---|---|
| lens | 1.660 | 1.600 |

Table 20 may list an effective radius in the first axis (X-axis) direction and an effective radius in the second axis (Y-axis) direction of each of the first lens 710 to the sixth lens 760. The first axis (X-axis) direction and the second axis (Y-axis) direction may indicate two directions perpendicular to the optical axis of each lens, and perpendicular to each other.

The first lens 710, the fourth lens 740 and the fifth lens 750 may have the same effective radius in the first axis (X-axis) direction and the same effective radius in the second axis (Y-axis) direction.

Effective radii in the first axis (X-axis) direction of an object-side surface and an image-side surface of the second lens 720 may be greater than the effective radii in the second axis (Y-axis) direction.

The effective radius of an object-side surface of the third lens 730 in the first axis (X-axis) direction may be greater than the effective radius in the second axis (Y-axis) direction. An image-side surface of the third lens 730 may have the same effective radius in the first axis (X-axis) direction and the same effective radius in the second axis (Y-axis) direction.

An object-side surface of the sixth lens 760 may have the same effective radius in the first axis (X-axis) direction and the same effective radius in the second axis (Y-axis) direction. An effective radius in the first axis (X-axis) direction of an image-side surface of the sixth lens 760 may be greater than the effective radius in the second axis (Y-axis) direction.

In the seventh embodiment, the first lens group G1 may have positive refractive power entirely, and the second lens group G1 may have positive refractive power entirely.

The effective radius of an object-side surface of the first lens 710 of the first lens group G1 may be greater than the effective radius of an image-side surface.

The first lens 710 may have positive refractive power, an object-side surface of the first lens 710 may be convex, and an image-side surface of the first lens 110 may be concave.

The second lens 720 may have positive refractive power, and an object-side surface and an image-side surface of the second lens 720 may be convex.

The third lens 730 may have negative refractive power, and an object-side surface and an image-side surface of the third lens 730 may be concave.

The fourth lens 740 may have negative refractive power, an object-side surface of the fourth lens 740 may be convex, and an image-side surface of the fourth lens 740 may be concave.

The fifth lens 750 may have positive refractive power, an object-side surface of the fifth lens 750 may be concave, and an image-side surface of the fifth lens 750 may be convex.

The sixth lens 760 may have negative refractive power, an object-side surface of the sixth lens 760 may be concave, and an image-side surface of the sixth lens 760 may be convex.

An aperture may be disposed between the second lens 720 and the third lens 730.

Each surface of the first lens 710 to the sixth lens 760 may have an aspherical coefficient, as in Table 21. For example, an object-side surface and an image-side surface of the first lens 710 to the fifth lens 750 may be aspherical, an object-side surface of the sixth lens 760 may be aspherical, and an image-side surface of the sixth lens 760 may be spherical.

TABLE 21

| | S1 | S2 | S6 | S7 | S8 | S9 |
|---|---|---|---|---|---|---|
| Conic | −4.4258E+00 | 6.3751E+00 | 8.0963E−01 | 3.7067E−02 | 7.4734E−01 | 0.0000E+00 |
| constant (K) | | | | | | |
| 4th order | 1.8951E−03 | 6.8235E−04 | −2.6667E−03 | 4.7975E−03 | −7.2631E−03 | 1.2738E−03 |
| coefficient (A) | | | | | | |
| 6th order | −1.5983E−04 | −2.6444E−04 | 3.0205E−04 | −3.1099E−03 | 6.5656E−03 | 1.3620E−03 |
| coefficient (B) | | | | | | |
| 8th order | 5.9614E−05 | 1.2376E−04 | −1.1140E−03 | 1.1186E−04 | −2.2791E−03 | 4.9594E−05 |
| coefficient (C) | | | | | | |
| 10th order | −1.3195E−05 | −3.4020E−05 | 6.5315E−04 | 1.2029E−03 | −8.1360E−05 | 4.0455E−05 |
| coefficient (D) | | | | | | |
| 12th order | 1.9005E−06 | 5.9594E−06 | −2.0569E−04 | −7.8914E−04 | 3.9382E−04 | 0.0000E+00 |
| coefficient (E) | | | | | | |
| 14th order | −1.7471E−07 | −6.6489E−07 | 3.1812E−05 | 2.4267E−04 | −1.4427E−04 | 0.0000E+00 |
| coefficient (F) | | | | | | |
| 16th order | 1.0002E−08 | 4.6018E−08 | −1.9307E−06 | −4.0031E−05 | 1.7750E−05 | 0.0000E+00 |
| coefficient (G) | | | | | | |
| 18th order | −3.2437E−10 | −1.8016E−09 | 0.0000E+00 | 3.4070E−06 | 0.0000E+00 | 0.0000E+00 |
| coefficient (H) | | | | | | |
| 20th order | 4.5480E−12 | 3.0480E−11 | 0.0000E+00 | −1.1883E−07 | 0.0000E+00 | 0.0000E+00 |
| coefficient (J) | | | | | | |

| | S10 | S11 | S12 | S13 | S14 |
|---|---|---|---|---|---|
| Conic | 0.0000E+00 | 1.5000E+01 | 4.2413E−01 | 0.0000E+00 | 0.0000E+00 |
| constant (K) | | | | | |
| 4th order | 8.8470E−03 | −6.0848E−03 | −9.3808E−04 | −2.6851E−03 | −7.3909E−03 |
| coefficient (A) | | | | | |
| 6th order | −6.4726E−04 | 4.3865E−04 | 7.7611E−04 | −1.2268E−03 | −1.4997E−03 |
| coefficient (B) | | | | | |
| 8th order | 2.8455E−04 | 9.9524E−04 | −2.9469E−04 | −1.0564E−03 | 9.1314E−05 |
| coefficient (C) | | | | | |
| 10th order | 1.8777E−04 | −7.1909E−04 | −1.9995E−04 | 2.6931E−04 | 0.0000E+00 |
| coefficient (D) | | | | | |
| 12th order | 0.0000E+00 | 1.4827E−04 | 6.9373E−05 | −6.5931E−06 | 0.0000E+00 |
| coefficient (E) | | | | | |
| 14th order | 0.0000E+00 | 0.0000E+00 | 0.0000E+00 | 0.0000E+00 | 0.0000E+00 |
| coefficient (F) | | | | | |
| 16th order | 0.0000E+00 | 0.0000E+00 | 0.0000E+00 | 0.0000E+00 | 0.0000E+00 |
| coefficient (G) | | | | | |
| 18th order | 0.0000E+00 | 0.0000E+00 | 0.0000E+00 | 0.0000E+00 | 0.0000E+00 |
| coefficient (H) | | | | | |
| 20th order | 0.0000E+00 | 0.0000E+00 | 0.0000E+00 | 0.0000E+00 | 0.0000E+00 |
| coefficient (J) | | | | | |

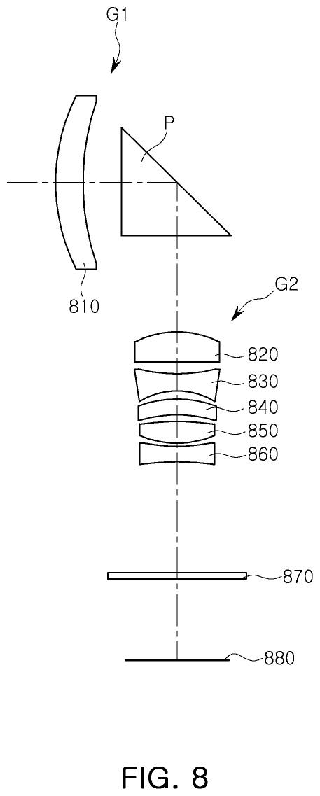

FIG. 8 is a configuration diagram illustrating an optical imaging system according to an eighth embodiment. The optical imaging system according to the eighth embodiment may be described with reference to FIG. 8.

The optical imaging system, according to the eighth embodiment, may include a first lens group G1 and a second lens group G2. The optical imaging system may include a reflective member P disposed between the first lens group G and the second lens group G2.

The first lens group Gr may include a first lens 810, and the second lens group G2 may include a second lens 820, a third lens 830, a fourth lens 840, a fifth lens 850 and a sixth lens 860, in order from an object side.

Also, the optical imaging system may further include a filter 870 and an image sensor.

The optical imaging system, according to the eighth embodiment, may form a focus on an imaging plane 880. The imaging plane 880 may refer to the surface on which focus is formed by the optical imaging system. As an example, the imaging plane 880 may refer to one surface of the image sensor in which light is received.

The reflective member P may be implemented as a prism, or may be provided as a mirror.

Lens characteristics (radius of curvature, thickness of the lens or distance between lenses, refractive index, Abbe number, and focal length) of each lens are listed in Table 22.

TABLE 22

| Surface | | Radius of | Thickness or | Refractive | Abbe | Focal |
|---|---|---|---|---|---|---|
| No. | Elements | curvature | distance | index | number | length |
| S1 | First | 9.264 | 1.200 | 1.535 | 55.7 | 37 |
| | lens | | | | | |
| S2 | | 16.567 | 1.800 | | | |
| S3 | Prism | Infinity | 2.250 | 1.785 | 25.7 | |
| S4 | | Infinity | 2.250 | 1.785 | 25.7 | |
| S5 | | Infinity | 4.190 | | | |
| S6 | Second | 4.063 | 1.294 | 1.535 | 55.7 | 7.220 |
| | lens | | | | | |
| S7 | aperture | −75.772 | 0.500 | | | |
| S8 | Third | −7.854 | 0.759 | 1.639 | 23.5 | −3.122 |
| | lens | | | | | |
| S9 | | 2.814 | 0.343 | | | |
| S10 | Fourth | 4.508 | 0.700 | 1.544 | 56.0 | 19.399 |
| | lens | | | | | |
| S11 | | 7.414 | 0.233 | | | |
| S12 | Fifth | 7.892 | 0.978 | 1.661 | 20.4 | 4.070 |
| | lens | | | | | |
| S13 | | −3.945 | 0.104 | | | |
| S14 | Sixth | −17.486 | 0.700 | 1.639 | 23.5 | −7.073 |
| | lens | | | | | |
| S15 | | 6.276 | 4.838 | | | |
| S16 | filter | Infinity | 0.210 | 1.517 | 64.2 | |
| S17 | | Infinity | 3.401 | | | |
| S18 | imaging | Infinity | | | | |
| | plane | | | | | |

TABLE 23

| | |
|---|---|
| Effective | Effective |
| radius | radius |
| in X-axis | in Y-axis |
| direction | direction |

| | |
|---|---|
| First | 3.750 |
| lens | 3.532 |

| | | |
|---|---|---|
| Second | 2.200 | 1.825 |
| lens | 1.997 | 1.825 |
| Third | 1.873 | 1.825 |

| | |
|---|---|
| lens | 1.611 |
| Fourth | 1.660 |
| lens | 1.639 |

| | | |
|---|---|---|
| Fifth | 1.660 | 1.600 |
| lens | 1.670 | 1.600 |
| Sixth | 1.640 | 1.600 |
| lens | 1.640 | 1.600 |

Table 23 may list an effective radius in the first axis (X-axis) direction and an effective radius in the second axis (Y-axis) direction of each of the first lens 810 to the sixth lens 860. The first axis (X-axis) direction and the second axis (Y-axis) direction may indicate two directions perpendicular to the optical axis of each lens, and perpendicular to each other.

The first lens 810 and the fourth lens 840 may have the same effective radius in the first axis (X-axis) direction and the same effective radius in the second axis (Y-axis) direction.

Effective radii in the first axis (X-axis) direction of an object-side surface and an image-side surface of each of the second lens 820, the fifth lens 850 and the sixth lens 860 may be greater than effective radiuses in the second axis (Y-axis) direction.

The effective radius of an object-side surface of the third lens 830 in the first axis (X-axis) direction may be greater than the effective radius in the second axis (Y-axis) direction. An image-side surface of the third lens 830 may have the same effective radius in the first axis (X-axis) direction and the same effective radius in the second axis (Y-axis) direction.

In the eighth embodiment, the first lens group G1 may have positive refractive power entirely, and the second lens group G1 may have positive refractive power entirely.

The effective radius of an object-side surface of the first lens 810 of the first lens group G1 may be greater than the effective radius of an image-side surface.

The first lens 810 may have positive refractive power, an object-side surface of the first lens 810 may be convex, and an image-side surface of the first lens 810 may be concave.

The second lens 820 may have positive refractive power, and an object-side surface and an image-side surface of the second lens 820 may be convex.

The third lens 830 may have negative refractive power, and an object-side surface and an image-side surface of the third lens 830 may be concave.

The fourth lens 840 may have positive refractive power, an object-side surface of the fourth lens 840 may be convex, and an image-side surface of the fourth lens 840 may be concave.

The fifth lens 850 may have positive refractive power, and an object-side surface and an image-side surface of the fifth lens 850 may be convex.

The sixth lens 860 may have negative refractive power, and an object-side surface and an image-side surface of the sixth lens 860 may be concave.

An aperture may be disposed between the second lens 820 and the third lens 830.

Each surface of the first lens 810 to the sixth lens 860 may have an aspherical coefficient, as in Table 24. For example, an object-side surface and an image-side surface of each of the first lens 810 to the sixth lens 860 may be aspherical.

TABLE 24

| | S1 | S2 | S6 | S7 | S8 | S9 |
|---|---|---|---|---|---|---|
| Conic | −5.2649E+00 | 7.6879E+00 | 9.5089E−01 | 3.7067E−02 | 1.4031E−01 | −1.1942E+00 |
| constant (K) | | | | | | |
| 4th order | 1.0995E−03 | 2.0188E−04 | 7.6103E−04 | 1.0025E−02 | −5.1113E−05 | −1.4954E−02 |
| coefficient (A) | | | | | | |
| 6th order | 2.6068E−04 | 4.2537E−04 | 4.5764E−04 | −1.8741E−03 | 2.0673E−04 | 1.4466E−03 |
| coefficient (B) | | | | | | |
| 8th order | −9.1334E−05 | −1.7715E−04 | −1.1028E−03 | −1.9844E−03 | 4.2896E−05 | 8.5462E−03 |
| coefficient (C) | | | | | | |
| 10th order | 2.0108E−05 | 4.6270E−05 | 6.5339E−04 | 1.6394E−03 | 4.6470E−06 | −7.7872E−03 |
| coefficient (D) | | | | | | |
| 12th order | −2.9042E−06 | −7.8068E−06 | −2.0455E−04 | −4.9983E−04 | 0.0000E+00 | 3.5462E−03 |
| coefficient (E) | | | | | | |
| 14th order | 2.7645E−07 | 8.5341E−07 | 3.2314E−05 | 2.7016E−05 | 0.0000E+00 | −8.4613E−04 |
| coefficient (F) | | | | | | |
| 16th order | −1.6495E−08 | −5.7900E−08 | −2.0089E−06 | 2.2025E−05 | 0.0000E+00 | 8.3809E−05 |
| coefficient (G) | | | | | | |
| 18th order | 5.5565E−10 | 2.2067E−09 | 0.0000E+00 | −5.1642E−06 | 0.0000E+00 | 0.0000E+00 |
| coefficient (H) | | | | | | |
| 20th order | −8.0213E−12 | −3.5981E−11 | 0.0000E+00 | 3.4327E−07 | 0.0000E+00 | 0.0000E+00 |
| coefficient (J) | | | | | | |
| | S10 | S11 | S12 | S13 | S14 | S15 |
| Conic | 0.0000E+00 | 0.0000E+00 | −9.7152E+00 | −1.5280E+00 | 0.0000E+00 | −4.6877E+00 |
| constant (K) | | | | | | |
| 4th order | −1.9070E−03 | 4.6047E−03 | −6.1387E−03 | 1.7760E−03 | −4.6329E−03 | −1.3147E−02 |
| coefficient (A) | | | | | | |
| 6th order | −1.4761E−04 | −4.5939E−05 | 1.3822E−03 | −2.6460E−04 | −1.4875E−03 | −8.0195E−06 |
| coefficient (B) | | | | | | |
| 8th order | −3.0613E−06 | −1.9452E−04 | 1.6592E−03 | −1.7454E−04 | −7.1600E−04 | 1.9780E−04 |
| coefficient (C) | | | | | | |
| 10th order | 1.1244E−05 | −7.3236E−06 | −8.9766E−04 | −7.0515E−05 | 3.6365E−04 | 4.6215E−05 |
| coefficient (D) | | | | | | |
| 12th order | 0.0000E+00 | 0.0000E+00 | 1.2034E−04 | 1.8472E−05 | −3.8986E−05 | −1.3389E−05 |
| coefficient (E) | | | | | | |
| 14th order | 0.0000E+00 | 0.0000E+00 | 0.0000E+00 | 0.0000E+00 | 0.0000E+00 | 0.0000E+00 |
| coefficient (F) | | | | | | |
| 16th order | 0.0000E+00 | 0.0000E+00 | 0.0000E+00 | 0.0000E+00 | 0.0000E+00 | 0.0000E+00 |
| coefficient (G) | | | | | | |
| 18th order | 0.0000E+00 | 0.0000E+00 | 0.0000E+00 | 0.0000E+00 | 0.0000E+00 | 0.0000E+00 |
| coefficient (H) | | | | | | |
| 20th order | 0.0000E+00 | 0.0000E+00 | 0.0000E+00 | 0.0000E+00 | 0.0000E+00 | 0.0000E+00 |
| coefficient (J) | | | | | | |

TABLE 25

| | Embodiment 1 | Embodiment 2 | Embodiment 3 | Embodiment 4 | Embodiment 5 | Embodiment 6 | Embodiment 7 | Embodiment 8 |
|---|---|---|---|---|---|---|---|---|
| SAG11 | 1.01449 | 0.929942 | 0.929891 | 0.966599 | 1.01083 | 1.01446 | 0.989874 | 0.989919 |
| SAG12 | 0.59263 | 0.55238 | 0.551089 | 0.590113 | 0.589051 | 0.59094 | 0.63984 | 0.572836 |
| f | 18.61 | 18.5822 | 18.5914 | 18.6095 | 18.6101 | 18.61 | 18.61 | 18.6104 |
| fG1 | 38 | 37.985 | 37.988 | 37.5 | 37 | 37 | 42.851 | 37 |
| fG2 | 27.1689 | 26.636 | 26.717 | 28.1399 | 30.4054 | 31.9427 | 28.5284 | 30.1433 |
| CA_L11 | 6.960 | 6.960 | 6.960 | 6.960 | 7.500 | 7.500 | 7.100 | 7.500 |
| CA_L21 | 3.650 | 3.650 | 3.650 | 3.650 | 3.650 | 3.650 | 3.650 | 3.650 |
| DR | 2.250 | 2.250 | 2.250 | 2.250 | 2.250 | 2.250 | 2.250 | 2.250 |
| Lf | 5.596 | 5.608 | 5.591 | 5.450 | 5.250 | 5.250 | 5.250 | 5.250 |
| Lr | 19.948 | 20.115 | 15.271 | 19.936 | 20.502 | 19.650 | 19.550 | 20.500 |
| Fno | 3.484 | 3.462 | 3.464 | 3.473 | 3.446 | 3.470 | 3.448 | 3.417 |

TABLE 26

| | Embodiment 1 | Embodiment 2 | Embodiment 3 | Embodiment 4 |
|---|---|---|---|---|
| R1/R2 | 0.639 | 0.639 | 0.639 | 0.649 |
| SAG11/SAG12 | 1.712 | 1.684 | 1.687 | 1.638 |
| fG1/f | 2.042 | 2.044 | 2.043 | 2.015 |
| fG1/fG2 | 1.399 | 1.426 | 1.422 | 1.333 |
| CA_L11/CAL21 | 1.907 | 1.907 | 1.907 | 1.907 |
| (Lf + DR)/CAL_21 | 2.150 | 2.153 | 2.148 | 2.110 |
| CA_L21/Fno | 1.048 | 1.054 | 1.054 | 1.051 |
| DP2/fG2 | 0.131 | 0.142 | 0.141 | 0.126 |
| fG1/f2 | 6.581 | 6.660 | 6.662 | 6.341 |
| f1/f2 | 6.581 | 6.660 | 6.662 | 6.341 |
| f2/f3 | −1.334 | −1.333 | −1.334 | −1.752 |
| (R1 − R2)/(R1 + R2) | −0.220 | −0.220 | −0.220 | −0.213 |
| Lf/Lr | 0.281 | 0.279 | 0.366 | 0.273 |
| | Embodiment 5 | Embodiment 6 | Embodiment 7 | Embodiment 8 |
| R1/R2 | 0.572 | 0.579 | 0.687 | 0.559 |
| SAG11/SAG12 | 1.716 | 1.717 | 1.547 | 1.728 |
| fG1/f | 1.988 | 1.988 | 2.303 | 1.988 |
| fG1/fG2 | 1.217 | 1.158 | 1.502 | 1.227 |
| CA_L11/CAL21 | 2.055 | 2.055 | 1.945 | 2.055 |
| (Lf + DR)/CAL_21 | 2.055 | 2.055 | 2.055 | 2.055 |
| CA_L21/Fno | 1.059 | 1.052 | 1.059 | 1.068 |
| DP2/fG2 | 0.125 | 0.113 | 0.125 | 0.139 |
| fG1/f2 | 5.157 | 5.613 | 8.252 | 5.125 |
| f1/f2 | 5.157 | 5.613 | 8.252 | 5.125 |
| f2/f3 | −2.210 | −1.544 | −0.892 | −2.312 |
| (R1 − R2)/(R1 + R2) | −0.273 | −0.266 | −0.186 | −0.283 |
| Lf/Lr | 0.256 | 0.267 | 0.269 | 0.256 |

According to the aforementioned embodiments, the optical imaging system may have a reduced size and may obtain a high-resolution image.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a reflective member having a reflective surface for changing a path of light;
a first lens group, disposed on a front side of the reflective member, comprising one or more lenses; and
a second lens group, disposed on a rear side of the reflective member, comprising a plurality of lenses,
wherein each of the first lens group and the second lens group has positive refractive power,
wherein an object-side surface of a frontmost lens disposed closest to an object side, among the one or more lenses of the first lens group, is convex, and
0.5<fG1/fG2<2.5 is satisfied, where fG1 is a focal length of the first lens group, and fG2 is a focal length of the second lens group.

2. The optical imaging system of claim 1, wherein the reflective member and the first lens group are configured to rotate with respect to two axes perpendicular to each other.

3. The optical imaging system of claim 2, wherein one of the two axes is an optical axis of the first lens group or an axis parallel to the optical axis of the first lens group.

4. The optical imaging system of claim 1,
wherein the reflective member comprises an incident surface to which light is incident and an emitting surface from which light is emitted, and the reflective surface is disposed between the incident surface and the emitting surface, and
wherein an effective diameter of an object-side surface of the frontmost lens of the first lens group and an effective diameter of an image-side surface of the frontmost lens of the first lens group are greater than a minor axis length of the incident surface of the reflective member.

5. The optical imaging system of claim 1, wherein 0.4<R1/R2<0.9 is satisfied, where R1 is a radius of curvature of the object-side surface of the frontmost lens of the first lens group, and R2 is a radius of curvature of an image-side surface of the frontmost lens of the first lens group.

6. The optical imaging system of claim 5, wherein −0.3<(R1−R2)/(R1+R2)<0 is satisfied.

7. The optical imaging system of claim 1, wherein 1<SAG11/SAG12<2.5 is satisfied, where SAG11 is an SAG value on an effective diameter end of the object-side surface of the frontmost lens of the first lens group, and SAG12 is an SAG value on an effective diameter end of an image-side surface of the frontmost lens of the first lens group.

8. The optical imaging system of claim 1, wherein 1<fG1/f<3 is satisfied, where f is a total focal length of the optical imaging system.

9. The optical imaging system of claim 1, wherein 1<CA_L11/CA_L21<3 is satisfied, where CA_L11 is an effective diameter of the object-side surface of the frontmost lens of the first lens group, and CA_L21 is an effective diameter of an object-side surface of a frontmost lens disposed closest to the reflective member among the plurality of lenses of the second lens group.

10. The optical imaging system of claim 1,
wherein the reflective member comprises an incident surface to which light is incident and an emitting surface from which light is emitted, and the reflective surface is disposed between the incident surface and the emitting surface, and
wherein 1.5<(Lf+DR)/CA_L21<3 is satisfied, where Lf is a distance from the object-side surface of the frontmost lens of the first lens group to the reflective surface, DR is a distance from the incident surface to the reflective surface, and CA_L21 is an effective diameter of an object-side surface of a frontmost lens disposed closest to the reflective member among the plurality of lenses of the second lens group.

11. The optical imaging system of claim 1, wherein 0.5 [mm]<CA_L21/Fno<2 [mm] is satisfied, where CA_L21 is an effective diameter of an object-side surface of a frontmost lens disposed closest to the reflective member among the plurality of lenses of the second lens group, and Fno is an F-number of the optical imaging system.

12. The optical imaging system of claim 1,
wherein the reflective member comprises an incident surface to which light is incident and an emitting surface from which light is emitted, and the reflective surface is disposed between the incident surface and the emitting surface, and
wherein DP2/fG2<0.4 is satisfied, where DP2 is a distance from the emitting surface to an object-side surface of a frontmost lens disposed closest to the reflective member among the plurality of lenses of the second lens group.

13. The optical imaging system of claim 1, wherein 3<fG1/f2<11 is satisfied, where f2 is a focal length of a frontmost lens disposed closest to the reflective member among the plurality of lenses of the second lens group.

14. The optical imaging system of claim 1, wherein −4<f2/f3<0 is satisfied, where f2 is a focal length of a frontmost lens disposed closest to the reflective member among the plurality of lenses of the second lens group, and f3 is a focal length of a lens disposed second closest to the reflective member among the plurality of lenses of the second lens group.

15. The optical imaging system of claim 1,
wherein the one or more lenses of the first lens group is a first lens, and
wherein the plurality of lenses of the second lens group comprises a second lens, a third lens, a fourth lens, a fifth lens and a sixth lens.

16. The optical imaging system of claim 15,
wherein an image-side surface of the first lens is concave,
wherein the second lens has positive refractive power, the third lens has negative refractive power, and
wherein a focal length of the first lens is greater than a focal length of the second lens.
